(19) United States
(12) Patent Application Publication
(10) Pub. No.: US 2020/0115630 A1
(43) Pub. Date: Apr. 16, 2020

(54) ADDITIVE STABILIZED COMPOSITE NANOPARTICLES

(71) Applicant: 3M INNOVATIVE PROPERTIES COMPANY, St. Paul, MN (US)

(72) Inventors: Wayne S. MAHONEY, St. Paul, MN (US); Michael C. PALAZZOTTO, Woodbury, MN (US)

(21) Appl. No.: 16/493,118

(22) PCT Filed: Mar. 12, 2018
(86) PCT No.: PCT/IB2018/051630

§ 371 Date: Sep. 11, 2019

Related U.S. Application Data
(60) Provisional application No. 62/471,074, filed on Mar. 14, 2017.

(51) Int. Cl. C09K 11/88; C09K 11/70; C09K 11/56; C09K 11/02; G02F 1/1335

(52) U.S. Cl. CPC C09K 11/883; C09K 11/70; G02F 2001/133507; C09K 11/025; G02F 1/133504; C09K 11/565

(57) ABSTRACT

Composite particles, compositions containing the composite particles, and articles containing the composite particles are provided. The composite particles contain a fluorescent core/shell nanoparticle and a stabilizing additive that includes a phosphine compound having at least three phosphorous-containing electron donor groups.

### CROSS REFERENCE TO RELATED APPLICATION

This application claims the benefit of U.S. Provisional Patent Application No. 62/471,074, filed Mar. 14, 2017, the disclosure of which is incorporated by reference herein in its entirety.

### BACKGROUND

Quantum Dot Enhancement Films (QDEF) are used as a component of the light source for LCD displays. Red and green quantum dots are used in QDEF with a blue LED as the light source to give the full spectrum of colors. This has the advantage of improving the color gamut over the typical LCD display and keeping the energy consumption low compared to LED displays.

Once the quantum dots are synthesized, they are often treated with an organic ligand that binds to the exterior surface of the quantum dot. Colloidal quantum dot nanoparticles (preferably, nanocrystals) that are stabilized with organic ligands and/or additives can have improved quantum yields due to passivating surface traps, controlling dispersion stability in a carrier fluid (or solvent) or cured polymeric binder, stabilizing against aggregation and degradation, and influencing the kinetics of nanoparticle (preferably, nanocrystal) growth during synthesis. Therefore, optimizing the organic ligand and/or additive is important for achieving optimal quantum yield, processability, and functional lifetime in QDEF.

### SUMMARY

Composite particles are provided that are capable of fluorescence and suitable for use in quantum dot enhancement films. Compositions and articles containing the composite particles are also provided. The compositions and articles can be used in optical displays.

In a first aspect, a composite particle is provided that comprises a fluorescent core/shell nanoparticle and a stabilizing additive comprising a phosphine compound having at least three phosphorous-containing electron donor groups.

In a second aspect, a composition is provided that comprises 1) composite particles and 2) a carrier fluid, a polymeric binder, a precursor of the polymeric binder, or a mixture thereof. The composite particles comprise a fluorescent core/shell nanoparticle and a stabilizing additive comprising a phosphine compound having at least three phosphorous-containing electron donor groups.

In a third aspect, an article is provided that comprises a quantum dot layer comprising composite particles dispersed in a polymeric binder, wherein the composite particles comprise a fluorescent core/shell nanoparticle and a stabilizing additive comprising a phosphine compound having at least three phosphorous-containing electron donor groups.

### BRIEF DESCRIPTION OF DRAWINGS

FIG. 1 is a schematic side elevation view of an edge region of an illustrative film article including quantum dots.

FIG. 2 is a flow diagram of an illustrative method of forming a quantum dot film.

FIG. 3 is a schematic illustration of an embodiment of a display including a quantum dot article.

### DETAILED DESCRIPTION

Composite particles are provided that contain a fluorescent core/shell nanoparticle and a stabilizing additive that includes a phosphine compound having at least three phosphorous-containing electron donor groups. The fluorescent core/shell nanoparticles are semiconductors that emit a fluorescence signal at a second wavelength of light when excited by a first wavelength of light that is shorter than the second wavelength of light. Compositions and articles containing the composite particles are also provided. The compositions and articles can be used in optical displays. In particular, the composite particles and the compositions can be used in quantum dot enhancement films or to prepare such films.

The composite nanoparticles can be used in conventional electronics, in semiconductor devices, in electrical systems, in optical systems, in consumer electronics, in industrial or military electronics, in nanocrystal, nanowire (NW), nano-rod, or nanotube sensing applications, in light-emitting diode (LED) lighting applications, and in nano-ribbon technologies.

The term “alkyl” means a linear or branched, cyclic or acyclic, saturated monovalent hydrocarbon.

“Alkylene” refers to a linear or branched divalent hydrocarbon that is saturated.

“Alkenyl” refers to a monovalent radical of an alkene. That is, the alkenyl is a non-aromatic hydrocarbon group having one or more carbon-carbon double bonds.

“Aryl” is a monovalent aromatic group containing 5-18 ring atoms and that contains a single aromatic ring or that contains at least one aromatic ring that is fused to one or more additional rings that are saturated, unsaturated, or aromatic. Examples of an aryl groups include phenyl, naphthyl, biphenyl, phenanthryl, and anthracyl. The aryl can be carbocyclic or can contain heteroatoms (i.e., the term aryl includes heteroaryl groups). A heteroaryl is an aryl that contains 1 to 3 heteroatoms such as nitrogen, oxygen, or sulfur. Some examples of heteroaryl groups are pyridyl, furanyl, pyrrolyl, thienyl, thiazolyl, oxazolyl, imidazolyl, indolyl, benzofuranyl, and benzthiazolyl. The aryl groups may be unsubstituted or substituted with one of more alkyl, alkoxy or halo groups.

“Alkaryl” means an alkyl-substituted aryl such as, for example, methylphenyl. This is equivalent to an arylene bonded to an alkyl.

“Arylene” means a polyvalent (usually divalent) aromatic group, such as phenylene, diphenylene, naphthalene, and the like.

“Aralkyl” means to an aryl-substituted alkyl. This is equivalent to an alkylene bonded to an aryl.

“Alkoxy” refers to a group of formula —OR where R is an alkyl as defined above.

The term “hydrocarbyl” refers to a hydrocarbon group such as, for example, alkyl, alkenyl, aryl, aralkyl, and alkylary groups. The hydrocarbyl group may be monovalent, divalent, or polyvalent.

The term “composite particle” refers to a nanoparticle, which is typically in the form of a fluorescent core/shell nanoparticle such as a nanocrystal having a stabilizing additive combined with, attached to, or associated with the fluorescent core/shell nanoparticle. The composite particles can be used to provide a tunable emission in the near ultraviolet (UV) to far infrared (IR) range.

The fluorescent core/shell nanoparticle included in the composite particle is a semiconductor material and is often referred to as a quantum dot. Thus, the terms “fluorescent core/shell nanoparticle”, “core/shell nanoparticle”, “fluorescent semiconductor nanoparticle”, “semiconductor nanoparticle”, “nanocrystal”, and “quantum dot” are used interchangeably.

The term “nanoparticle” refers to a particle having an average particle diameter in the range of 0.1 to 1000 nanometers such as in the range of 0.1 to 100 nanometers or in the range of 1 to 100 nanometers. The term “diameter” refers not only to the diameter of substantially spherical particles but also to the distance along the smallest axis of the structure. Suitable techniques for measuring the average particle diameter include, for example, scanning tunneling microscopy, light scattering, and transmission electron microscopy.

The “core” of a nanoparticle is understood to mean a nanoparticle (preferably, a nanocrystal) to which no shell has been applied or to the inner portion of a core/shell nanoparticle. The core of a nanoparticle can have a homogenous composition or its composition can vary with depth inside the core. Many materials are known and used in core nanoparticles, and many methods are known in the art for applying one or more shells to a core nanoparticle. The “shell” is a layer (or layers) that partially or completely surrounds the core. The core has a different composition than the one more shells of the core/shell nanoparticle.

As used herein, the term “actinic radiation” refers to radiation in any wavelength range of the electromagnetic spectrum. The actinic radiation is typically in the ultraviolet wavelength range, in the visible wavelength range, in the infrared wavelength range, or combinations thereof. Any suitable energy source known in the art can be used to provide the actinic radiation.

In a first aspect, a composite particle is provided that comprises a fluorescent core/shell nanoparticle and a stabilizing additive containing a phosphine compound having at least three phosphorous-containing electron donor groups.

Any suitable fluorescent core/shell nanoparticle can be included in the composite particle. The core/shell nanoparticles are typically fluorescent semiconductor nanoparticles that emit a fluorescence signal when suitably excited. That is, the fluorescent semiconductor nanoparticles fluoresce at a second wavelength of actinic radiation when excited by a first wavelength of actinic radiation that is shorter than the second wavelength. In some embodiments, the fluorescent semiconductor nanoparticles can fluoresce in the visible region of the electromagnetic spectrum when exposed to wavelengths of light in the ultraviolet region of the electromagnetic spectrum. In other embodiments, the fluorescent semiconductor nanoparticles can fluoresce in the infrared region when excited in the ultraviolet or visible regions of the electromagnetic spectrum. In still other embodiments, the fluorescent semiconductor nanoparticles can fluoresce in the ultraviolet region when excited in the ultraviolet region by a shorter wavelength of light, can fluoresce in the visible region when excited by a shorter wavelength of light in the visible region, or can fluoresce in the infrared region when excited by a shorter wavelength of light in the infrared region. The fluorescent semiconductor nanoparticles are often capable of fluorescing in a wavelength range such as, for example, at a wavelength up to 1200 nanometers (nm), or up to 1000 nm, up to 900 nm, or up to 800 nm. For example, the fluorescent semiconductor nanoparticles are often capable of fluorescence in the range of 400 to 800 nanometers.

The fluorescent semiconductor nanoparticles have an average particle diameter of at least 0.1 nanometer (nm), or at least 0.5 nm, or at least 1 nm. The nanoparticles have an average particle diameter of up to 1000 nm, or up to 500 nm, or up to 200 nm, or up to 100 nm, or up to 50 nm, or up to 20 nm, or up to 10 nm. Semiconductor nanoparticles, particularly with sizes (i.e., average particle diameters) on the scale of 1 to 10 nm, have emerged as a category of the most promising advanced materials for cutting-edge technologies.

Semiconductor materials include elements or complexes of Group 2-Group 16, Group 12-Group 16, Group 13-Group 15, Group 14-Group 16, and Group 14 semiconductors of the Periodic Table (using the modern group numbering system of 1-18). Some suitable quantum dots include a metal phosphide, a metal selenide, a metal telluride, or a metal sulfide. Exemplary semiconductor materials include, but are not limited to, Si, Ge, Sn, BN, BP, BAs, AlN, AlP, AlAs, AlSb, GaN, GaP, GaAs, GaSb, InN, InP, InAs, InSb, AlN, AlP, AlAs, AlSb, GaN, GaP, GaAs, GaSb, ZnO, ZnS, ZnSe, ZnTe, CdS, CdSe, CdTe, HgS, HgSe, HgTe, BeS, BeSe, BeTe, MgS, MgSe, MgTe, GeS, GeSe, GeTe, SnS, SnSe, SnTe, PbO, PbS, PbSe, PbTe, CuF, CuCl, CuBr, CuI, Si₃N₄, Ge₃N₄, Al₂O₃, (Ga,In)₂(S,Se,Te)₃, Al₂CO, CaS, CaSe, CaTe, SrS, SrSe, SrTe, BaS, BaSe, BaTe, and an appropriate combination of two or more such semiconductors. These semiconductor materials can be used for the core, the one or more shell layers, or both.

In certain embodiments, the fluorescent semiconductor nanoparticles are metal phosphide quantum dots such as indium phosphide and gallium phosphide, metal selenide quantum dots such as cadmium selenide, lead selenide, and zinc selenide, metal sulfide quantum dots such as cadmium sulfide, lead sulfide, and zinc sulfide, or metal telluride quantum dots such as cadmium telluride, lead telluride, and zinc telluride. Other suitable quantum dots include gallium arsenide and indium gallium phosphide. Exemplary semiconductor materials are commercially available from Evident Thermoelectrics (Troy, N.Y.), and from Nanosys Inc. (Milpitas, Calif.).

Nanocrystals (or other nanostructures) for use in the fluorescent core/shell nanoparticles can be produced using any method known to those skilled in the art. Suitable methods are disclosed in, for example, in Patent Application Publication WO 2005/022120 (Scher et al.), U.S. Patent Application Publication 2008/0118755 (Whiteford et al.), U.S. Pat. No. 6,949,206 (Whiteford), U.S. Patent Application Publication 2006/0040103 (Whiteford et al.), U.S. Patent Application Publication 2012/0031486 (Parce et al.), U.S. Pat. No. 8,088,483 (Whiteford et al.), and U.S. Pat. No. 9,139,767 (Dubrow). The nanocrystals (or other nanostructures) can be produced from any suitable material, suitably an inorganic material, and more suitably an inorganic conductive or semiconductor material. Suitable semiconductor materials include those disclosed in the above references and can include any type of semiconductor, including group II-VI, group III-V, group IV-VI and group IV semiconductors. Suitable semiconductor materials include, but are not limited to, Si, Ge, Sn, Se, Te, B, C (including diamond), P, BN, BP, BAs, AlN, AlP, AlAs, AlSb, GaN, GaP, GaAs, GaSb, InN, InP, InAs, InSb, AlN, AlP, As, AlSb, GaN, GaP, GaAs, GaSb, ZnO, ZnS, ZnSe, ZnTe, CdS, CdSe, CdTe, HgS, HgSe, HgTe, BeS, BeSe, BeTe, MgS, MgSe, GeS, GeSe, GeTe, SnS, SnSe, SnTe, PbO, PbS, PbSe, PbTe, CuF, CuCl, CuBr, CuI, Si₃N₄, Ge₃N₄, Al₂O₃, (Ga, In)₂(S, Se, Te)₃, Al₂CO, and an appropriate combination of two or more such semiconductors.

In certain embodiments, the semiconductor nanocrystals or other nanostructures may comprise a dopant selected from a p-type dopant or an n-type dopant. The nanocrystals (or other nanostructures) useful in the present invention can also comprise Group 12-Group 16 or Group 13-Group 15 semiconductor materials. Examples of Group 12-Group 16 or Group 13-Group 15 semiconductor nanocrystals and nanostructures include any combination of an element from Group 12, such as Zn, Cd and Hg, with any element from Group 16, such as S, Se, Te, Po, of the Periodic Table; and any combination of an element from Group 13, such as B, Al, Ga, In, and Tl, with any element from Group 15, such as N, P, As, Sb and Bi, of the Periodic Table.

Other suitable inorganic nanostructures include metal nanostructures. Suitable metals include, but are not limited to, Ru, Pd, Pt, Ni, W, Ta, Co, Mo, Ir, Re, Rh, Hf, Nb, Au, Ag, Ti, Sn, Zn, Fe, FePt, and the like.

While any known method can be used to create semiconductor nanocrystals or other nanostructures, suitably, a solution-phase colloidal method for controlled growth of inorganic nanoparticles can be used (see Alivisatos, A. P., “Semiconductor clusters, nanocrystals, and quantum dots,” Science, 271:933 (1996); X. Peng, M. Schlamp, A. Kadavanich, A. P. Alivisatos, “Epitaxial growth of highly luminescent CdSe/CdS Core/Shell nanocrystals with photostability and electronic accessibility,” J. Am. Chem. Soc., 30:7019-7029 (1997); and C. B. Murray, D. J. Norris, M. G. Bawendi, “Synthesis and characterization of nearly monodisperse CdE (E=sulfur, selenium, tellurium) semiconductor nanocrystallites,” J. Am. Chem. Soc., 115:8706 (1993)). This manufacturing process technology leverages low cost processability without the need for clean rooms and expensive manufacturing equipment. In these methods, metal precursors that undergo pyrolysis at high temperature are rapidly injected into a hot solution of organic surfactant molecules. These precursors break apart at elevated temperatures and react to nucleate nanocrystals. After this initial nucleation phase, a growth phase begins by the addition of monomers to the growing crystal. The result is freestanding crystalline nanoparticles in solution that have an organic surfactant molecule coating their surface.

Utilizing this approach, synthesis occurs as an initial nucleation event that takes place over seconds, followed by crystal growth at elevated temperature for several minutes. Parameters such as the temperature, types of surfactants present, precursor materials, and ratios of surfactants to monomers can be modified so as to change the nature and progress of the reaction. The temperature controls the structural phase of the nucleation event, rate of decomposition of precursors, and rate of growth. The organic surfactant molecules mediate both solubility and control of the nanocrystal shape.

In semiconductor nanocrystals, photo-induced emission arises from the band edge states of the nanocrystal. The band-edge emission from nanocrystals competes with radiative and non-radiative decay channels originating from surface electronic states (see X. Peng, et al., J. Am. Chem. Soc., 119 (30), 7019-7029 (1997)). As a result, the presence of surface defects such as dangling bonds provide non-radiative recombination centers and contribute to lowered emission efficiency. An efficient and permanent method to passivate and remove the surface trap states is to epitaxially grow an inorganic shell material on the surface of the nanocrystal (see X. Peng, et al., J. Am. Chem. Soc., 30:7019-7029 (1997)). The shell material can be chosen such that the electronic levels are type I with respect to the core material (e.g., with a larger bandgap to provide a potential step localizing the electron and hole to the core). As a result, the probability of non-radiative recombination can be reduced.

Core-shell structures can be obtained by adding organometallic precursors containing the shell materials to a reaction mixture containing the core nanocrystal. In this case, rather than a nucleation-event followed by growth, the cores act as the nuclei, and the shells grow from their surface. The temperature of the reaction is kept low to favor the addition of shell material monomers to the core surface, while preventing independent nucleation of nanocrystals of the shell materials. Surfactants in the reaction mixture are present to direct the controlled growth of shell material and ensure solubility. A uniform and epitaxial grown shell is obtained when there is a low lattice mismatch between the two materials. Additionally, the spherical shape acts to minimize interfacial strain energy from the large radius of curvature, thereby preventing the formation of dislocations that could degrade the optical properties of the nanocrystal system.

In suitable embodiments, ZnS can be used as the shell material using known synthetic processes, resulting in the formation of quantum dots having a high-quality emission. If necessary, this material can be easily substituted (e.g., if the core material is modified). Additional exemplary core and shell materials are described herein and/or known in the art.

For many applications of quantum dots, two factors are typically considered in selecting a material. The first factor is the ability to absorb and emit visible light. This consideration makes InP a highly desirable base material. The second factor is the material's photoluminescence efficiency (quantum yield). Generally, Group 12-16 quantum dots (such as cadmium selenide) have higher quantum yield than Group 13-15 quantum dots (such as InP). The quantum yield of InP cores produced previously has been very low (less than 1 percent), and therefore the production of a core/shell structure with InP as the core and another semiconductor compound with higher bandgap (e.g., ZnS) as the shell has been pursued in attempts to improve the quantum yield.

Thus, the fluorescent semiconductor nanoparticles (i.e., quantum dots) of the present disclosure include a core and a shell at least partially surrounding the core. The core/shell nanoparticles can have two distinct layers, a semiconductor or metallic core and a shell surrounding the core of an insulating or semiconductor material. The core often contains a first semiconductor material and the shell often contains a second semiconductor material that is different than the first semiconductor material. For example, a first Group 12-16 (e.g., CdSe) semiconductor material can be present in the core and a second Group 12-16 (e.g., ZnS) semiconductor material can be present in the shell.

In certain embodiments, the core includes a metal phosphide (e.g., indium phosphide (InP), gallium phosphide (GaP), aluminum phosphide (AlP)), a metal selenide (e.g., cadmium selenide (CdSe), zinc selenide (ZnSe), magnesium selenide (MgSe)), or a metal telluride (e.g., cadmium telluride (CdTe), zinc telluride (ZnTe)). In certain embodiments, the core includes a metal phosphide (e.g., indium phosphide) or a metal selenide (e.g., cadmium selenide). In certain preferred embodiments, the core includes a metal phosphide (e.g., indium phosphide).

The shell can be a single layer or multilayered. In some embodiments, the shell is a multilayered shell. The shell can include any of the core materials described herein. In certain embodiments, the shell material can be a semiconductor material having a higher bandgap energy than the semiconductor core. In other embodiments, suitable shell materials can have good conduction and valence band offset with respect to the semiconductor core, and in some embodiments, the conduction band can be higher and the valence band can be lower than those of the core. For example, in certain embodiments, semiconductor cores that emit energy in the visible region such as, for example, CdS, CdSe, CdTe, ZnSe, ZnTe, GaP, InP, or GaAs, or near IR region such as, for example, InP, InAs, InSb, PbS, or PbSe may be coated with a shell material having a bandgap energy in the ultraviolet regions such as, for example, ZnS, GaN, and magnesium chalcogenides such as MgS, MgSe, and MgTe. In other embodiments, semiconductor cores that emit in the near IR region can be coated with a material having a bandgap energy in the visible region such as CdS or ZnSe.

Formation of the core/shell nanoparticles may be carried out by a variety of methods. Suitable core and shell precursors useful for preparing semiconductor cores are known in the art and can include Group 2 elements, Group 12 elements, Group 13 elements, Group 14 elements, Group 15 elements, Group 16 elements, and salt forms thereof. For example, a first precursor may include metal salt (M+X−) including a metal atom (M+) such as, for example, Zn, Cd, Hg, Mg, Ca, Sr, Ba, Ga, In, Al, Pb, Ge, Si, or in salts and a counter ion (X−), or organometallic species such as, for example, dialkyl metal complexes. The preparation of a coated semiconductor nanocrystal core and core/shell nanocrystals can be found in, for example, Dabbousi et al., J. Phys. Chem. B, 101: 9463 (1997), Hines et al., J. Phys. Chem., 100: 468-471 (1996), and Peng et al., J. Amer. Chem. Soc., 119: 7019-7029 (1997), as well as in U.S. Pat. No. 8,283,412 (Liu et al.) and Patent Application Publication No. WO 2010/039897 (Tulsky et al.).

In certain preferred embodiments, the shell includes a metal sulfide (e.g., zinc sulfide or cadmium sulfide). In certain embodiments, the shell includes a zinc-containing compound (e.g., zinc sulfide or zinc selenide). In certain embodiments, a multilayered shell includes an inner shell over-coating the core, wherein the inner shell includes zinc selenide and zinc sulfide. In certain embodiments, a multilayered shell includes an outer shell over-coating the inner shell, wherein the outer shell includes zinc sulfide.

In some embodiments, the core of the shell/core nanoparticle contains a metal phosphide such as indium phosphide, gallium phosphide, or aluminum phosphide. The shell contains zinc sulfide, zinc selenide, or a combination thereof. In some more particular embodiments, the core contains indium phosphide and the shell is multilayered with the inner shell containing both zinc selenide and zinc sulfide and the outer shell containing zinc sulfide.

The thickness of the shell(s) may vary among embodiments and can affect fluorescence wavelength, quantum yield, fluorescence stability, and other photo-stability characteristics of the nanocrystal. The skilled artisan can select the appropriate thickness to achieve desired properties and may modify the method of making the core/shell nanoparticles to achieve the appropriate thickness of the shell(s).

The diameter of the fluorescent semiconductor nanoparticles (i.e., quantum dots) can affect the fluorescence wavelength. The diameter of the quantum dot is often directly related to the fluorescence wavelength. For example, cadmium selenide quantum dots having an average particle diameter of about 2 to 3 nanometers tend to fluoresce in the blue or green regions of the visible spectrum while cadmium selenide quantum dots having an average particle diameter of about 8 to 10 nanometers tend to fluoresce in the red region of the visible spectrum.

The fluorescent semiconductor nanoparticles are combined with a stabilizing additive to provide composite particles. As used herein, the “stabilizing” effect of the stabilizing additive can refer to enhancing the dispersibility of the fluorescent semiconductor nanoparticles in a carrier fluid, in a polymeric binder, in a precursor of the polymeric binder, or in a mixture thereof. That is the stabilizing additive may increase the amount of time that the fluorescent semiconductor nanoparticles remain suspended or dispersed in the carrier fluid, the polymeric binder, in a precursor of the polymeric binder, or in a mixture thereof. The stabilizing additive may increase compatibility of the fluorescent semiconductor nanoparticles with the other components of a composition (e.g., a carrier fluid, a polymeric binder, a precursor of the polymeric binder, or a mixture thereof). The enhanced stabilization tends to result in improved performance characteristics such as improved quantum yields (i.e., improved quantum efficiencies) and/or the fluorescence stability (i.e., less degradation of the fluorescence intensity with time, and/or reduced shift in the peak wavelength of the fluorescence emitted light over time, and/or reduced broadening of the spectrum of emitted light over time (e.g., this is typically recorded as the width in nanometers of the peak at half the maximum intensity, which is often referred to as full width at half maximum intensity (FWHM)).

Stabilization involves combining the fluorescent semiconductor nanoparticles with the stabilizing additive or with a mixture of stabilizing additives. In this context, the terms “combining”, “combination”, “attach”, and “attached” refers to creating a stable dispersion (e.g., by hand mixing, mechanical mixing) of the stabilizing additive and the fluorescent semiconductor nanoparticle in a carrier fluid, in a polymeric binder, in a precursor of the polymeric binder, or in a mixture thereof. This combination results in the fluorescent semiconductor nanoparticles being more suitable for their intended use by improving the stability of the dispersion and/or increasing the quantum yield. The combination of the stabilizing additive with the fluorescent semiconductor nanoparticle may reduce (e.g., minimize) or prevent degradation (e.g., photo- or thermal-degradation).

Various methods can be used to combine the fluorescent semiconductor nanoparticles with the stabilizing additive to form the composite particles. For example, the stabilizing additive and the fluorescent semiconductor nanoparticles can be combined at room temperature or heated at an elevated temperature (e.g., at least 50° C., at least 60° C., at least 80° C., or at least 90° C.) for an extended period of time (e.g., at least 5 minutes, at least 1 hour, at least 5 hours, at least 10 hours, at least 15 hours, or at least 20 hours). The combination process can include the addition of an organic solvent. That is, the stabilizing additive and the fluorescent semiconductor nanoparticles are mixed together in the presence of an organic solvent.

If desired, any by-product of the combination process or any solvent used in combination process can be removed, for example, by distillation, by rotary evaporation, or by precipitation and centrifugation of the mixture followed by decanting the liquid. The product of the combination process is the composite particles. In some embodiments, the composite particles are dried to a powder. In other embodiments, the organic solvent used for the combination process is compatible (i.e., miscible) with any carrier fluid used in compositions in which the composite particles are included. In these embodiments, at least a portion of the solvent used for the combination process can be included in the carrier fluid in which the composite particles are dispersed.

In some embodiments, the stabilizing additives may function as surface modifying ligands that attach to the surface of the fluorescent semiconductor nanoparticles. This attachment may modify the surface characteristics of the fluorescent semiconductor nanoparticles. The additives may attach to the surface, for example, by adsorption, absorption, formation of an ionic bond, formation of a covalent bond, formation of a hydrogen bond, or a combination thereof.

Quantum efficiency (also known in the literature as quantum yield) is the number of defined events which occur per photon absorbed (e. g., the ratio of the number of photons emitted by the nanoparticles per photon absorbed by the nanoparticles). Accordingly, one general embodiment of the present disclosure provides a population of nanoparticles that displays a quantum efficiency of at least 0.45, at least 0.50, at least 0.55, at least 0.60, or at least 0.65 or even greater. Expressed as a percentage, the quantum yield is at least 45 percent or greater, at least 50 percent, at least 55 percent, at least 60 percent, or at least 65 percent or even greater.

The change in quantum efficiency is often less than 30 percent when the composite particles are exposed to visible light for two hours using two fluorescent bulbs (each 15 Watts) according to the test procedure described below in the Examples. That is, the change is quantum efficiency is calculated as follows.

[(Initial quantum efficiency−Final quantum efficiency)÷Initial quantum efficiency]×100%

In some embodiments, the change in quantum efficiency is less than 25 percent, less than 20 percent, or no greater than 15 percent.

The change in emission peak width, which is usually recorded at full width of the peak at half its maximum height (FWHM), is often less than 5 nm when the composite particles are exposed to visible light for two hours using two fluorescent bulbs (each 15 Watts) according to the test procedure described below in the Examples. This change (difference) is calculates as follows.

Initial FWHM−Final FWHM

The change is often less than 4 nm, less than 3 nm, less than 2 nm, or less than 1 nm.

The stabilizing additive, which can be referred to as the first stabilizing additive, includes a phosphine compound that has at least three phosphorous-containing electron donor groups. Any such phosphine compound can be used. One stabilizing additive or multiple first stabilizing additive can be combined with the fluorescent core/shell nanoparticles.

There is often at least one aromatic group attached to each phosphorous atom in the first stabilizing additive. That is, there are at least three, at least four, or at least five aromatic groups in the first stabilizing additive and these groups are often attached to one of the phosphorous atoms. In some first stabilizing additives, there are at least two aromatic groups attached to at least one, at least two, or at least three of the phosphorous atoms.

In some embodiments, the first stabilizing additive is of Formula (I).

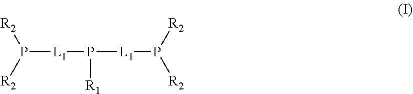

In Formula (I), each L₁ is independently an alkylene, arylene, or combination thereof. The group R₁ is an alkyl, aryl, alkaryl, aralkyl, or group of formula -L₂-P(R₂)₂. Each R₂ is independently an alkyl, aryl, alkaryl, aralkyl, or two R₂ groups together with the phosphorous atom to which they are both attached form a ring structure. Group L₂ is an alkylene.

Each group L₁ in Formula (I) is independently an alkylene, arylene, or combination thereof. Suitable alkylene groups are divalent and often have 1 to 20 carbon atoms, 1 to 16 carbon atoms, 1 to 10 carbon atoms, 1 to 8 carbon atoms, 1 to 6 carbon atoms, or 1 to 4 carbon atoms. The alkylene can be linear of branched (if there are at least 3 carbon atoms). Suitable arylene groups are divalent and have 6 to 18 carbon atoms, 6 to 12 carbon atoms, 6 to 10 carbon atoms, or 6 carbon atoms. The arylene group has 6 to 18 carbon atoms, 6 to 12 carbon atoms, or 6 carbon atoms. The arylene is often phenylene and the two attached phosphorous-containing groups can be arranged in the ortho, meta, or para configuration. As used with reference to group L₁, a “combination thereof” refers to one or more alkylene groups attached to one or more arylene groups.

The group R₁ in Formula (I) is an alkyl, aryl, alkaryl, aralkyl, or group of formula L₂-P(R₂)₂. Suitable alkyl groups often have 1 to 20 carbon atoms, 1 to 16 carbon atoms, 1 to 10 carbon atoms, 1 to 8 carbon atoms, 1 to 6 carbon atoms, or 1 to 4 carbon atoms. Some alkyl groups are cyclic alkyl groups having 5 to 10 carbon atoms. Suitable aryl groups often have 6 to 18 carbon atoms, 6 to 12 carbon atoms, 6 to 10 carbon atoms, or 6 carbon atoms. The aryl is often phenyl. Suitable alkaryl groups often include an arylene having 6 to 18 carbon atoms, 6 to 12 carbon atoms, or 6 carbon atoms attached to an alkyl having 1 to 10 carbon atoms, 1 to 6 carbon atoms, or 1 to 4 carbon atoms. Suitable aralkyl often have an alkylene with 1 to 10 carbon atoms, 1 to 6 carbon atoms, or 1 to 4 carbon atoms attached to an aryl having 6 to 18 carbon atoms, 6 to 12 carbon atoms, or 6 carbon atoms. In the group L₂-P(R₂)₂, L₂ is an alkylene and R₂ is defined below. Suitable alkylene L₂ groups are divalent and often have 1 to 10 carbon atoms, 1 to 8 carbon atoms, 1 to 6, or 1 to 4 carbon atoms. The alkylene can be linear of branched (if there are at least 3 carbon atoms).

Each R₂ in Formula (I) is independently an alkyl, aryl, alkaryl, aralkyl, or two R₂ groups together with the phosphorous atom to which they are both attached form a ring structure. Suitable alkyl groups often have 1 to 20 carbon atoms, 1 to 16 carbon atoms, 1 to 10 carbon atoms, 1 to 8 carbon atoms, 1 to 6, or 1 to 4 carbon atoms. Some alkyl groups are cyclic alkyl groups having 5 to 10 carbon atoms. Suitable aryl groups often have 6 to 18 carbon atoms, 6 to 12 carbon atoms, 6 to 10 carbon atoms, or 6 carbon atoms. The aryl is often phenyl. Suitable alkaryl groups often include an arylene having 6 to 18 carbon atoms, 6 to 12 carbon atoms, or 6 carbon atoms attached to an alkyl having 1 to 10 carbon atoms, 1 to 6 carbon atoms, or 1 to 4 carbon atoms. Suitable aralkyl often have an alkylene with 1 to 10 carbon atoms, 1 to 6 carbon atoms, or 1 to 4 carbon atoms attached to an aryl having 6 to 18 carbon atoms, 6 to 12 carbon atoms, or 6 carbon atoms. Two R₂ groups attached to the same phosphorous atom can combine to form a heterocyclic ring structure containing the phosphorous atom. The heterocyclic ring typically does not contain other heteroatoms other than phosphorous and the ring can be saturated or unsaturated (but is often saturated). The heterocyclic ring often has 5 to 7 ring members.

In some stabilizing additives of Formula (I), each R₂ is an aryl, alkaryl, or aralkyl. In some particular embodiments, each R₂ is an aryl such as phenyl.

In some stabilizing additives of Formula (I), each R₂ is an aryl, alkaryl, or aralkyl and R₁ is an aryl, alkaryl, or aralkyl. In some particular embodiments, each R₂ and R₁ is an aryl such as phenyl.

In some stabilizing additives of Formula (I), each R₂ is an aryl, alkaryl, or aralkyl, group R₁ is an aryl, alkaryl, or aralkyl, and group L₁ is an alkylene. In some particular embodiments, each R₂ and R₁ is an aryl such as phenyl and L₁ is a linear alkylene having 1 to 6 carbon atoms or 1 to 4 carbon atoms. One such example is

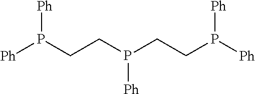

where Ph is phenyl. This compound is C.A.S. [23582-02-7].

In other stabilizing additives of Formula (I), each R₂ is an aryl, alkaryl, or aralkyl, group R₁ is an aryl, alkaryl, or aralkyl, and group L₁ is an arylene. In some particular embodiments, each R₂ and R₁ is an aryl such as phenyl and L₁ is an arylene with the two attached phosphorous-containing groups arranged in an ortho configuration. One example is

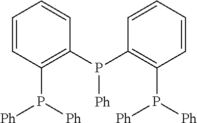

where Ph is phenyl. This compound can be prepared as described in Li et al., Organometallics, 34, 5009-5014 (2015).

In still other stabilizing additives of Formula (I), each R₂ is an aryl, alkaryl, or aralkyl, group R₁ is of formula -L₂-P(R₂)₂, and groups L₁ and L₂ are each an alkylene. In some particular embodiments, each R₂ is an aryl such as phenyl, and each L₁ and L₂ is an alkylene having 1 to 10 carbon atoms, 1 to 6 carbon atoms, or 1 to 4 carbon atoms. One example is

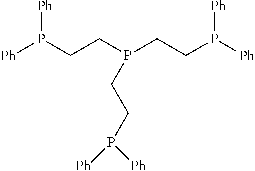

where Ph is phenyl. This compound is C.A.S. [23582-03-8].

In other embodiments, the first stabilizing additive is of Formula (II).

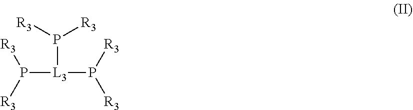

In Formula (II), each R₃ is independently an alkyl, aryl, alkaryl, aralkyl, or two R₃ groups together with the phosphorous atom to which they are both attached combine to form a ring structure. The group L₃ is an alkane-triyl or a trivalent group of formula N(L₄)₃ where each L₄ is an alkylene.

Each group R₃ in Formula (II) is independently an alkyl, aryl, alkaryl, aralkyl, or two R₃ groups together with the phosphorous atom to which they are both attached form a ring structure. Suitable alkyl groups often have 1 to 20 carbon atoms, 1 to 16 carbon atoms, 1 to 10 carbon atoms, 1 to 8 carbon atoms, 1 to 6, or 1 to 4 carbon atoms. Some alkyl groups are cyclic alkyl groups having 5 to 10 carbon atoms. Suitable aryl groups often have 6 to 18 carbon atoms, 6 to 12 carbon atoms, 6 to 10 carbon atoms, or 6 carbon atoms. The aryl is often phenyl. Suitable alkaryl groups often include an arylene having 6 to 18 carbon atoms, 6 to 12 carbon atoms, or 6 carbon atoms attached to an alkyl having 1 to 10 carbon atoms, 1 to 6 carbon atoms, or 1 to 4 carbon atoms. Suitable aralkyl often have an alkylene with 1 to 10 carbon atoms, 1 to 6 carbon atoms, or 1 to 4 carbon atoms attached to an aryl having 6 to 18 carbon atoms, 6 to 12 carbon atoms, or 6 carbon atoms. Two R₃ groups attached to the same phosphorous atom can combine with the phosphorous atom to form a heterocyclic ring structure. The heterocyclic ring typically does not contain other heteroatoms other than phosphorous and the ring can be saturated or unsaturated (but is often saturated). The heterocyclic ring often has 5 to 7 ring members.

Group R₃ in Formula (II) is a trivalent group. In some embodiments, group R₃ is a trivalent radial of an alkane, which is an alkane-triyl. The alkane-triyl often has 1 to 16 carbon atoms, 1 to 10 carbon atoms, 1 to 6 carbon atoms, or 1 to four carbon atoms. In other embodiment, group R₃ is a trivalent group of formula N(L₄)₃. That is, the group is of formula

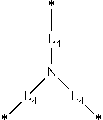

where the asterisks denote the site of bonding to the three phosphorous-containing groups. Each L₄ is an alkylene such as an alkylene having 1 to 10 carbon atoms, 1 to 6 carbon atoms, or 1 to 4 carbon atoms.

In some stabilizing additives of Formula (II), each R₃ is an aryl, aralkyl, or alkaryl. In some particular embodiments, each R₃ is an aryl such as phenyl.

In some stabilizing additives of Formula (II), each R₃ is an aryl, aralkyl, or alkaryl and L₃ is an alkane-triyl. In some particular embodiments, each R₃ is an aryl such as phenyl and L₃ is an alkane-triyl having 1 to 10 carbon atoms, 1 to 6 carbon atoms, or 1 to 4 carbon atoms. One example is

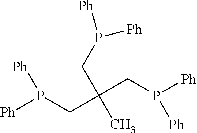

where each Ph is phenyl. This compound is C.A.S. [22031-12-5]. Another example is

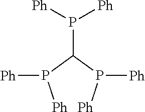

where each Ph is phenyl. This compound is C.A.S. [28926-65-0].

In other stabilizing additives of Formula (II), a first R₃ group attached to each phosphorous atom is an aryl, aralkyl, or alkaryl, a second R₃ group attached to each phosphorous atom is an alkyl, and L₃ is an alkane-triyl. In some particular embodiments, each first R₃ group is an aryl such as phenyl, each second R₃ group is an alkyl having 1 to 10 carbon atoms, 1 to 6 carbon atoms, or 1 to 4 carbon atoms, and L₃ is an alkane-triyl having 1 to 10 carbon atoms, 1 to 6 carbon atoms, or 1 to 4 carbon atoms. One example is

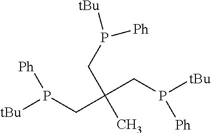

where Ph is phenyl and tBu is tert-butyl. The synthesis of this compound is described in Mustafa et al., Inorganic Chimica Acta, 270 (1-2), pp. 499-510, April 1998.

In yet other stabilizing additives of Formula (II), two R₃ groups combined with the phosphorous atom to which they are both attached to form a ring structure and group L₃ is an alkane-triyl. In some embodiments, the two R₃ groups combine with the phosphorous atom to form a saturated heterocyclic ring having 5 to 7 ring members and L₃ is an alkane-triyl having 1 to 10 carbon atoms, 1 to 6 carbon atoms, or 1 to 4 carbon atoms. One example is

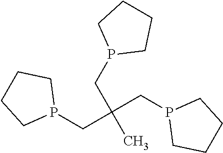 [SMILES: CC(CP1CCCC1)(CP1CCCC1)CP1CCCC1]

The synthesis of this compound is described in Mustafa et al., Inorganic Chimica Acta, 270 (1-2), pp. 499-510, April 1998.

In still other stabilizing additives of Formula (II), each R₃ is an aryl, aralkyl, or alkaryl and L₃ is trivalent group of formula N(L₄)₃ with each L₄ is an alkylene. In some particular embodiments, each R₃ is an aryl such as phenyl and each L₄ is an alkylene having 1 to 10 carbon atoms, 1 to 6 carbon atom, or 1 to 4 carbon atoms. One example is

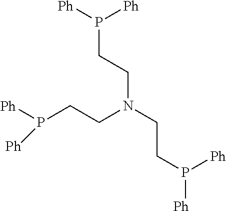

where each Ph is phenyl. The synthesis of this compound is described in Cecconi et al., J. Chem. Soc. Dalton Trans., 211-216 (1989).

The fluorescent semiconductor nanoparticles are often supplied in the form of a dispersion in a carrier fluid. The amount of stabilizing additive is often at least 0.1 weight percent and can be up to 10 weight percent based on total weight this dispersion. In some examples, the amount of stabilizing additive is at least 0.5 weight percent, at least 1 weight percent, at least 2 weight percent, or at least 3 weight percent and up to 10 weight percent, up to 8 weight percent, or up to 6 weight percent based on the total weight of the fluorescent semiconductor nanoparticles and the carrier fluid.

In some embodiments, the fluorescent semiconductor nanoparticles are treated with a surface modifying ligand compound. The surface modifying ligand compound has a ligand group selected from —CO₂H, —SO₃H, —P(O)(OH)₂, —OP(O)(OH), —OH and —NH₂. In some embodiments, the surface modifying ligand compound is of Formula (III).

R₁₁—(X)ₙ (III)

In Formula (III), group R₁₁ is a (hetero)hydrocarbyl group having 2 to 30 carbon atoms. The variable n is an integer equal to at least one (such as, for example, 1 to 5, 1 to 4, or 1 to 3), and X is a ligand group selected from —COOH, —SO₃H, —P(O)(OH)₂, —OP(O)(OH), —OH, —SH, and —NH₂.

In Formula (III), the term (hetero)hydrocarbyl includes both heterohydrocarbyl and hydrocarbyl. The heterohydrocarbyl can include heteroatoms such as N, S, or O. The heterohydrocarbyl and hydrocarbyl R₁₁ group can have up to 30 carbon atoms, up to 20 carbon atoms, up to 16 carbon atoms, up to 10 carbon atoms, up to 8 carbon atoms, or up to 6 carbon atoms. The heterohydrocarbyl can have 2 to 10 heteroatoms, 2 to 8 heteroatoms, 2 to 6 heteroatoms, or 2 to 4 heteroatoms. The hydrocarbyl or heterohydrocarbyl can be saturated or unsaturated. In some embodiments, the variable n is equal to 1 and R₁₁ is an alkyl or alkenyl group. In some embodiments, multiple surface modifying ligand compounds are used.

Some example surface modifying ligand compounds include, but are not limited to, C₂₋₁₈ alkylcarboxylic acids, C₂₋₁₈ alkenylcarboxylic acids, C₂₋₁₈ alkylsulfonic acids, C₂₋₁₈ alkenylsulfonic acids, C₂₋₁₈ phosphonic acids, C₂₋₁₈ alkylamines, C₂₋₁₈ alkenylamines, and the like. The surface modifying ligand can have multiple X groups such as, for example, multiple carboxyl groups as in various alkylsuccinic acids. In some embodiments, the surface modifying ligand compound is oleic acid, stearic acid, palmitic acid, lauric acid, dodecylsuccinic acid, hexylphosphonic acid, n-octylphosphonic acid, tetradecylphosphonic acid, octadecylphosphonic acid, n-octyl amine, or hexadecyl amine. In other embodiments, the surface modifying ligand compound is a malonic acid derivative such as in the compounds described in Patent Application Publication WO 2015/09032 (Vogel). Specific malonic acid derivatives include, but are not limited to, tridecylmalonic acid, bis(4,6,6-trimethylhexyl)malonic acid, and 2-(3,5,5-trimethylhexylidine)propanedioic acid.

The surface modifying ligand compounds of Formula (III) may be added at the time the fluorescent semiconductor nanoparticles are synthesized. As result, the fluorescent semiconductor nanoparticles may be functionalized with the surface modifying ligand compounds of Formula (III) resulting from the original synthesis of the nanoparticles. For example, InP nanoparticles may be purified by bonding with dodecylsuccinic acid (DDSA) and lauric acid (LA) first, following by precipitation from ethanol. The precipitated nanoparticles may have some of the acid functional ligands attached thereto. Similarly, CdSe nanoparticles may be functionalized with amine-functional ligands as result of their preparation. Thus, the composite particles can include fluorescent nanoparticles that are treated with the surface modifying ligand compounds of Formula (III) and then combined with the first stabilizing additive having at least three phosphorous-containing groups (e.g., such as the first stabilizing compounds of Formula (I) or (II)).

Alternatively, the surface modifying ligand compounds of Formula (III) can be added to the fluorescent semiconductor nanoparticles along with the first stabilizing additive having at least three phosphorous-containing groups. The surface modifying ligand compounds can be present in amounts sufficient to provide up to a monolayer of the surface modifying ligand on the fluorescent semiconductor nanoparticles. An excess of the surface modifying ligand compound can be added, if desired, to drive the equilibrium sufficiently to provide monolayer coverage.

Various methods can be used to treat the fluorescent semiconductor nanoparticles with the surface modifying ligand compounds of Formula (III). In some embodiments, procedures similar to those described in U.S. Pat. No. 7,160,613 (Bawendi et al.) and U.S. Pat. No. 8,283,412 (Liu et al.) can be used. For example, the surface modifying ligand compound and the fluorescent semiconductor nanoparticles can be heated at an elevated temperature (e.g., at least 50° C., at least 60° C., at least 80° C., or at least 90° C.) for an extended period of time (e.g., at least 1 hour, at least 5 hours, at least 10 hours, at least 15 hours, or at least 20 hours).

If desired, optional stabilizing additives (a second stabilizing additive) can be combined with the first stabilizing additive having at least three phosphorus atoms described above. The optional second stabilizing additive typically has one or two arsenic-containing groups, one or two antimony-containing groups, or one or two phosphorous containing groups. In many embodiments, the second stabilizing additive, if used, has one or two phosphorous-containing groups.

The optional second stabilizing additive can be of Formula (IV).

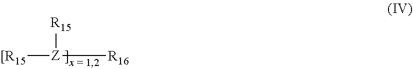

In Formula (IV), group R₁₅ is a tri(alkyl)silyl group or a hydrocarbyl group such as an alkyl, alkenyl, aryl, alkaryl, or aralkyl. The hydrocarbyl R₁₅ group optionally can be substituted with a halo or alkoxy. When the variable x is equal to 1, group R₁₆ is equal to R₁₅. That is, R₁₆ is an alkyl, alkenyl, aryl, alkaryl, aralkyl, or tri(alkyl)silyl wherein any of these groups optionally can be substituted with a halo or alkoxy. When the variable x is equal to 2, R₁₆ is a divalent alkylene. Group Z is P, As or Sb.

Group R₁₅ is a tri(alkyl)silyl group or a hydrocarbyl such as an alkyl, alkenyl, aryl, alkaryl, or aralkyl. Suitable alkyl groups for the tri(alkyl)silyl group or the hydrocarbyl group often have 1 to 20 carbon atoms, 1 to 16 carbon atoms, 1 to 10 carbon atoms, 1 to 8 carbon atoms, 1 to 6, or 1 to 4 carbon atoms. Suitable aryl groups often have 6 to 18 carbon atoms, 6 to 12 carbon atoms, 6 to 10 carbon atoms, or 6 carbon atoms. Some alkyl groups are cyclic alkyl groups having 5 to 10 carbon atoms. The aryl is often phenyl or biphenyl or naphthyl. Suitable alkaryl groups often include an arylene having 6 to 18 carbon atoms, 6 to 12 carbon atoms, or 6 carbon atoms attached to an alkyl having 1 to 10 carbon atoms, 1 to 6 carbon atoms, or 1 to 4 carbon atoms. Suitable aralkyl often have an alkylene with 1 to 10 carbon atoms, 1 to 6 carbon atoms, or 1 to 4 carbon atoms attached to an aryl having 6 to 18 carbon atoms, 6 to 12 carbon atoms, or 6 carbon atoms. In many embodiments, R₁₅ is an aryl, alkaryl, or aralkyl. In some more particular embodiments, there are at least two aryl, alkaryl, or aralkyl groups in the compound of Formula (IV). In some even more particular embodiments, R₁₅ is phenyl, tolyl, biphenyl, benzyl, or naphthyl.

If x is equal to 2, R₁₆ is an alkylene. Suitable alkylene groups often have 1 to 20 carbon atoms, 1 to 10 carbon atoms, 1 to 6 carbon atoms, or 1 to 4 carbon atoms. If x is equal to 1, R16 is the same as described above for R₁₅.

Some example second stabilizing additives of Formula (IV) are phosphine compounds (Z is equal to P). Suitable phosphine compounds that can be used as the second stabilizing additive include, but are not limited to, trimethylphosphine, triethylphosphine, tri-n-propylphosphine, triisopropylphosphine, tri-n-butylphosphine, tri-sec-butylphosphine, tri-i-butylphosphine, tri-t-butylphosphine, tricyclopentylphosphine, triallylphosphine, tricyclohexylphosphine, triphenylphosphine, trinaphthylphosphine, tri-p-tolylphosphine, tri-o-tolylphosphine, tri-m-tolylphosphine, tribenzylphosphine, tri(p-trifluoromethylphenyl)phosphine, tris(trifluoromethyl)phosphine, tri(p-fluorophenyl)phosphine, tri(p-trifluoromethylphenyl)phosphine, allyldiphenylphosphine, benzyldiphenylphosphine, bis(2-furyl)phosphine, bis(4-methoxyphenyl)phenylphosphine, bis(4-methylphenyl)phosphine, bis(3,5-bis(trifluoromethyl)phenyl)phosphine, t-butylbis(trimethylsilyl)phosphine, t-butyldiphenylphosphine, cyclohexyldiphenylphosphine, diallylphenylphosphine, dibenzylphosphine, dibutylphenylphosphine, dibutylphosphine, di-t-butylphosphine, dicyclohexylphosphine, diethylphenylphosphine, di-i-butylphosphine, dimethylphenylphosphine, dimethyl(trimethylsilyl)phosphine, diphenylmethylphosphine, diphenylpropylphosphine, diphenyl(p-tolyl)phosphine, diphenyl(trimethylsilyl)phosphine, diphenylvinylphosphine, divinylphenylphosphine, ethyldiphenylphosphine, (2-methoxyphenyl)methyl phenylphosphine, di-n-octylphenylphosphine, tris(2,6-dimethoxyphenyl)phosphine, tris(2-furyl)phosphine, tris(2-methoxyphenyl)phosphine, tris(3-methoxyphenyl)phosphine, tris(4-methoxyphenyl)phosphine, tris(3-methoxypropyl)phosphine, tris(2-thienyl)phosphine, tris(2,4,6-trimethylphenyl)phosphine, tris(trimethylsilyl)phosphine, isopropyldiphenylphosphine, dicyclohexylphenylphosphine, (+)-neomenthyldiphenylphosphine, tribenzylphosphine, diphenyl(2-methoxyphenyl)phosphine, diphenyl(pentafluorophenyl)phosphine, bis(pentafluorophenyl)phenylphosphine, and tris(pentafluorophenyl)phosphine. Exemplary bidentate stabilizing additives (Formula (IV) where x is equal to 2) include but are not limited to, (R)-(+)-2,2′-Bis(diphenylphosphino)-1,1′-binaphthyl; bis(phenylphosphino)methane, 1,2-bis(phenylphosphino)ethane, 1,2-bis(diphenylphosphino)ethane, bis(diphenylphosphino)methane, 1,3-bis(diphenylphosphino)propane and 1,4-bis(diphenylphosphino)butane.

Other suitable optional second stabilizing additives are arsines and stibines of Formula (V)

Z₁(R₁₇)₃ (V)

wherein Z₁ is arsenic or antimony and R₁₇ is selected from hydrocarbyl groups including alkyl, aryl, alkaryl and aralkyl. Suitable alkyl groups often have 1 to 20 carbon atoms, 1 to 16 carbon atoms, 1 to 10 carbon atoms, 1 to 8 carbon atoms, 1 to 6, or 1 to 4 carbon atoms. Some alkyl groups are cyclic alkyl groups having 5 to 10 carbon atoms. Suitable aryl groups often have 6 to 18 carbon atoms, 6 to 12 carbon atoms, 6 to 10 carbon atoms, or 6 carbon atoms. Representative alkyl groups include but are not limited to methyl, ethyl, propyl, isopropyl, n-butyl, isobutyl, sec-butyl, tert-butyl, pentyl, neopentyl, hexyl, heptyl, octyl, nonyl, decyl, and dodecyl. Some alkyl groups are cycloalkyl groups such as those containing 5 to 10 carbon atoms. Representative cycloalkyl groups include but are not limited to cyclopentyl and cyclohexyl. The aryl often has 6 to 18 carbon atoms, 6 to 12 carbon atoms, or 6 to 10 carbon atoms. Examples include phenyl, biphenyl, and naphthyl. Suitable alkaryl groups often include an arylene having 6 to 18 carbon atoms, 6 to 12 carbon atoms, or 6 carbon atoms attached to an alkyl having 1 to 10 carbon atoms, 1 to 6 carbon atoms, or 1 to 4 carbon atoms. Suitable aralkyl often have an alkylene with 1 to 10 carbon atoms, 1 to 6 carbon atoms, or 1 to 4 carbon atoms attached to an aryl having 6 to 18 carbon atoms, 6 to 12 carbon atoms, or 6 carbon atoms. In many embodiments, R₁₇ is an aryl, alkaryl, or aralkyl. In some more particular embodiments, there are at least two aryl, alkaryl, or aralkyl groups in the compound of Formula (V). In some even more particular embodiments, R₁₇ is phenyl, tolyl, biphenyl, benzyl, naphthyl, or phenylethyl (i.e., —CH₂CH₂-Ph).

Representative arsines of Formula (V) include, but are not limited to, triphenylarsine, tritolylarsine, and trinapthylarsine. Representative stibines of Formula (V) include, but are not limited to, triphenylstibine and tritolylstibine.

If desired, any by-product of the synthesis process for preparing the fluorescent semiconductor nanoparticles or any organic solvent used in surface-modification process or in the process of combining the fluorescent semiconductor nanoparticles with a stabilizing additive (with a first stabilizing additive, a second stabilizing additive, or both) can be removed, for example, by distillation, rotary evaporation, or by precipitation of the nanoparticles and centrifugation of the mixture followed by decanting the liquid to leave behind the treated fluorescent semiconductor nanoparticles (e.g., the composite particles). In some embodiments, the treated fluorescent semiconductor nanoparticles are dried to a powder after treatment. In other embodiments, the organic solvent used for the treatment is compatible (i.e., miscible) with any carrier fluids, polymeric binder, precursor of the polymeric binder, or mixture thereof used in various compositions in which the composite particles are included. In these embodiments, at least a portion of the organic solvent used for the treatment can be included in the composition containing the composite particles.

The first stabilizing additives of Formula (I) and (II), the optional ligand compounds of Formula (III), and the optional second stabilizing additives of Formula (IV) and (V) may function, at least in part, to reduce the number of aggregated fluorescent semiconductor nanoparticles within a composition. The formation of aggregated fluorescent semiconductor nanoparticles can alter the fluorescent characteristics or quantum efficiency of the composition.

In a second aspect, a composition is provided that comprises 1) composite particles and 2) a carrier fluid, a polymeric binder, a precursor of the polymeric binder, or a mixture thereof. The composite particles comprise a fluorescent core/shell nanoparticle and a stabilizing additive comprising a phosphine compound having at least three phosphorous-containing electron donor groups.

The terms “composition” can refer to a curable or cured composition. The term can be used interchangeably with the term “dispersion composition”, which typically refers to a composition containing the fluorescent semiconductor nanoparticles dispersed in a carrier fluid, a polymeric binder, a precursor of the polymeric binder, or a mixture thereof. In some embodiments, the composite particles are dispersed in a carrier fluid. In other embodiments, the composite particles are dispersed in a polymeric binder or in a precursor of the polymeric binder. In other embodiments, the composite particles are dispersed in a carrier fluid to form a first dispersion and droplets of this first dispersion are dispersed in a polymeric binder or a precursor of the polymeric binder. The carrier fluid can be polymeric or non-polymeric. The polymeric binder can be cured (crosslinked), if desired. In many articles, the polymeric binder is cured to minimize degradation of the fluorescent semiconductor nanoparticles resulting from exposure to oxygen.

The dispersion composition often (sometime preferably) includes a non-aqueous carrier fluid. As used herein, the term “non-aqueous” means that no water is purposefully added to the compositions. However, a small amount of water might be present as an impurity in other components or might be present as a reaction by-product of a surface modification process or the polymerization process. The carrier fluids are typically selected to be compatible (i.e., miscible) with the stabilizing additive having at least three phosphorous-containing groups and with any optional stabilizing additives and/or surface modifying ligand compounds used to form the composite particles.

Suitable non-polymeric carrier fluids include, but are not limited to, aromatic hydrocarbons (e.g., toluene, benzene, or xylene), aliphatic hydrocarbons such as alkanes (e.g., cyclohexane, heptane, hexane, or octane), alcohols (e.g., methanol, ethanol, isopropanol, or butanol), ketones (e.g., acetone, methyl ethyl ketone, methyl isobutyl ketone, or cyclohexanone), aldehydes, amines, amides, esters (e.g., amyl acetate, ethylene carbonate, propylene carbonate, or methoxypropyl acetate), glycols (e.g., ethylene glycol, propylene glycol, butylene glycol, triethylene glycol, diethylene glycol, hexylene glycol, or glycol ethers such as those commercially available from Dow Chemical, Midland, Mich. under the trade designation DOWANOL), ethers (e.g., diethyl ether), dimethyl sulfoxide, tetramethylsulfone, halocarbons (e.g., methylene chloride, chloroform, or hydrofluoroethers), or combinations thereof. In some embodiments, the preferred carrier fluids include aromatic hydrocarbons such as toluene and aliphatic hydrocarbons such as alkanes.

The optional non-polymeric carrier fluids are typically inert liquids at 25° C. that have a boiling point less than or equal to 100° C. or less than or equal to 150° C. The carrier fluid can be a mixture of compounds. Higher boiling points are often preferred so that the carrier fluids remain when organic solvents used in the various preparation processes are removed. Because the fluorescent semiconductor nanoparticles and/or the composite particles are often prepared in an organic solvent, the carrier fluid enables separation and removal of the organic solvent.

In some embodiments, the carrier fluid is an oligomeric or polymeric material. The polymeric carrier fluids provide a medium of intermediate viscosity that can be desirable for further processing of the composite particles into a thin film. The polymeric carrier fluid is often selected to form a homogenous dispersion with the composite particles but to be incompatible with the polymeric binders and/or with precursors of the polymeric binder. The polymeric carrier fluids are usually liquid at 25° C. and include, but are not limited to, polysiloxanes such as polydimethylsiloxane, liquid fluorinated polymers such as perfluoropolyethers, poly(acrylates), and polyethers such as poly(ethylene glycol), poly(propylene glycol), and poly(butylene glycol). In some embodiments, the preferred polymeric carrier fluid is a polysiloxane such as polydimethylsiloxane.

The optional stabilizing additive is desirably soluble in a carrier fluid at room temperature. It is typically added in an amount in a range of 0.1 weight percent to 10 weight percent based on the weight of a dispersion of the fluorescent semiconductor and the carrier fluid. In some examples, the amount of stabilizing additive is at least 0.5 weight percent, at least 1 weight percent, at least 2 weight percent, or at least 3 weight percent and up to 10 weight percent, up to 8 weight percent, or up to 6 weight percent based on the total weight of the fluorescent semiconductor nanoparticles and the carrier fluid.

The composite particles and carrier fluid usually form a dispersion composition that is preferably transparent when viewed with the human eye. Likewise, any polymeric binder or precursors of the polymeric binders that are included in the dispersion composition are often selected to be soluble in the carrier fluid. The dispersion composition can be used, for example, to form a coating that is preferably transparent when viewed with the unaided human eye. The term transparent means that the coating transmits at least 85 percent of incident light in the visible region of the electromagnetic spectra (about 400-700 nm wavelength).

The polymeric binders desirably provide barrier properties to exclude oxygen and moisture. If water and/or oxygen enter the fluorescent semiconductor material (i.e., quantum dot), it can degrade and ultimately fail to emit light when excited by ultraviolet or blue light irradiation. Slowing or eliminating quantum dot degradation along the laminate edges is particularly important to extend the service life of the displays in smaller electronic devices such as those utilized in, for example, handheld devices and tablets. To provide these desirable barrier properties, crosslinked (cured) polymeric binders are typically selected.

Exemplary polymeric binders include, but are not limited to, polysiloxanes, fluoroelastomers, polyamides, polyimides, polycarolactones, polycaprolactams, polyurethanes, polyethers, polyvinyl chlorides, polyvinyl acetates, polyesters, polycarbonates, polyacrylates, polymethacrylates, polyacrylamides, and polymethacrylamides. These materials are typically crosslinked (i.e., cured).

Suitable precursors of the polymeric binder include any precursor materials used to prepare the polymeric binders listed above. That is, the precursors of the polymeric binder are the reactants that are used to form the cured polymeric binders. Exemplary precursor materials include acrylates that can be polymerized to polyacrylates, methacrylates that can be polymerized to form polymethacrylates, acrylamides that can be polymerized to form polyacrylamides, methacrylamides that can be polymerized to form polymethacrylamides, epoxy resins and dicarboxylic acids that can be polymerized to form polyesters, diepoxides that can be polymerized to form polyethers, isocyanates and polyols that can be polymerized to form polyurethanes, or polyols and dicarboxylic acids that can be polymerized to form polyesters.

In some embodiments, the polymeric binder is a thermally curable epoxy-amine composition optionally further comprising a radiation-curable acrylate as described in Patent Application Publication WO 2015095296 (Eckert et al.), thiol-epoxy resins as described in Patent Application Publication WO 2016/167927 (Qiu et al.), thiol-alkene-epoxy resins as described in Patent Application Publication WO 2016/168048 (Qiu et al.), thiol-alkene resins as described in WO 2016/081219 (Qui et al.), and thiol silicones as described in Patent Application Publication WO 2015/138174 (Qiu et al.). Such polymeric materials can be used, for example, with composite particles containing CdSe nanoparticles.

In some preferred embodiments, the precursor of the polymeric binder is a radiation curable oligomer of Formula (VI).

R₂₀-(L₅-Q₁)_{d} (VI)

In Formula (VI), the group R₂₀ is a polymeric (usually an oligomeric) group. Group L₅ is a linking group. Group Q₁ is a pendent, free-radically polymerizable group. The variable d is typically an integer greater than 1 or greater than 2.

The linking group L₅ between groups R₂₀ and Q₁ is a divalent or higher valency group selected from an alkylene, arylene, heteroalkylene, or combinations thereof (as used to describe L₅, the groups alkylene, arylene, and heteroalkylene are divalent or polyvalent) and an optional divalent group selected from carbonyl, ester, amide, sulfonamide, or combinations thereof. Group L₅ can be unsubstituted or substituted with an alkyl, aryl, halo, or combinations thereof. The L₅ group typically has no more than 30 carbon atoms. In some compounds, the L₅ group has no more than 20 carbon atoms, no more than 10 carbon atoms, no more than 6 carbon atoms, or no more than 4 carbon atoms. For example, L₅ can be an alkylene, an alkylene substituted with an aryl group, or an alkylene in combination with an arylene or an alkyl ether or alkyl thioether linking group.

The pendent, free radically polymerizable functional groups Q₁ is typically an ethylenically unsaturated group and may be selected from the group consisting of vinyl, vinyl ether, ethynyl, and (meth)acryloyl, which includes groups of formula CH₂═CH—(CO)—O—, CH₂═C(CH₃)—(CO)—O—, CH₂═CH—(CO)—NH—, and CH₂═C(CH₃)—(CO)—NH—.

In many embodiments, group R₂₀ is considered to be an oligomeric group having a weight average molecular weight (M_{w}) as determined by Gel Permeation Chromatography of at least 500 g/mole or at least 1,000 g/mole and typically less than 50,000 g/mole. The group R₂₀ is often selected from a poly(meth)acrylate, polyurethane, polyepoxide, polyester, polyether, polysulfide, polybutadiene, hydrogenated polyolefins (including hydrogenated polybutadienes, isoprenes and ethylene/propylene copolymers), and polycarbonate.

As used herein, “(meth)acrylated oligomer” means a polymeric material having at least two pendent (meth)acryloyl groups and having a weight average molecular weight (M_{w}) as determined by Gel Permeation Chromatography of at least 1,000 g/mole and typically less than 50,000 g/mole.

(Meth)acryloyl epoxy oligomers are multifunctional (meth)acrylate esters and amides of epoxy resins, such as the (meth)acrylated esters of bisphenol-A epoxy resin. Examples of commercially available (meth)acrylated epoxies oligomers include those known by the trade designations EBECRYL 600 (bisphenol A epoxy diacrylate), EBECRYL 605 (EBECRYL 600 with 25 weight percent tripropylene glycol diacrylate), EBECRYL 3700 (bisphenol-A diacrylate) and EBECRYL 3720H (bisphenol A diacrylate with 20 weight percent hexanediol diacrylate) available from Allnex USA Inc., Alpharetta, Ga.; PHOTOMER 3016 (bisphenol A epoxy acrylate), PHOTOMER 3016-40R (epoxy acrylate and 40 weight percent tripropylene glycol diacrylate blend), and PHOTOMER 3072 (modified bisphenol A acrylate, etc.) available from BASF Corp., Cincinnati, Ohio; and EBECRYL 3708 (modified bisphenol A epoxy diacrylate) available from Allnex USA Inc., Alpharetta, Ga.

(Meth)acrylated urethane oligomers are multifunctional (meth)acrylate esters of hydroxy terminated isocyanate extended polyols, polyesters, or polyethers. (Meth)acrylated urethane oligomers can be synthesized, for example, by reacting a diisocyanate or other polyvalent isocyanate compound with a polyvalent polyol (including polyether and polyester polyols) to yield an isocyanate terminated urethane prepolymer. A polyester polyol can be formed by reacting a polybasic acid (e.g., terephthalic acid or maleic acid) with a polyhydric alcohol (e.g., ethylene glycol or 1,6-hexanediol). A polyether polyol useful for making the acrylate functionalized urethane oligomer can be chosen from, for example, polyethylene glycol, polypropylene glycol, poly(tetrahydrofuran), poly(2-methyl-tetrahydrofuran), poly(3-methyl-tetrahydrofuran) and the like. Alternatively, the polyol linkage of the (meth)acrylated urethane oligomer can be a polycarbonate polyol.

Subsequently, (meth)acrylates having a hydroxyl group can then be reacted with the terminal isocyanate groups of the prepolymer. Both aromatic and the preferred aliphatic isocyanates can be used to react with the urethane to obtain the oligomer. Examples of diisocyanates useful for making the (meth)acrylated oligomers are 2,4-tolylene diisocyanate, 2,6-tolylene diisocyanate, 1,3-xylylene diisocyanate, 1,4-xylylene diisocyanate, 1,6-hexane diisocyanate, isophorone diisocyanate, and the like. Examples of hydroxy terminated acrylates useful for making the acrylated oligomers include, but are not limited to, 2-hydroxyethyl (meth)acrylate, 2-hydroxypropyl (meth)acrylate, α-hydroxybutyl acrylate, polyethylene glycol (meth)acrylate, and the like.

A (meth)acrylated urethane oligomer can be, for example, any urethane oligomer having at least two and generally less than about six (meth)acrylate functionalities. Suitable (meth)acrylated urethane oligomers are also commercially available such as, for example, those known by the trade designations PHOTOMER 6008, 6019, and 6184 (aliphatic urethane triacrylates) available from Henkel Corp.; EBECRYL 220 (hexafunctional aromatic urethane acrylate), EBECRYL 284 (aliphatic urethane diacrylate), EBECRYL 4830 (aliphatic urethane diacrylate), and EBECRYL 6602 (trifunctional aromatic urethane acrylate), available from UCB Chemical; and SARTOMER CN1963, 963E75, 945A60, 963B80, 968, and 983, available from Sartomer Co., Exton, Pa.

Properties of these curable polymeric binders may be varied depending upon selection of the type of isocyanate, the type of polyol modifier, the reactive functionality, and molecular weight. Diisocyanates are widely used in urethane (meth)acrylate synthesis and can be divided into aromatic and aliphatic diisocyanates. Aromatic diisocyanates are used for manufacture of aromatic urethane (meth)acrylates that have significantly lower cost than aliphatic urethane (meth)acrylates but tend to noticeably yellow on white or light colored substrates. Aliphatic urethane (meth)acrylates include aliphatic diisocyanates that exhibit slightly more flexibility than aromatic urethane acrylates that include the same functionality and a similar polyol modifier, and that have a similar molecular weight.

Some curable polymeric binders comprise a functionalized poly(meth)acrylate oligomer, which may be obtained from the reaction product of: (a) from 50 to 99 parts by weight of (meth)acrylate ester monomer units that are homo- or co-polymerizable to a polymer and (b) from 1 to 50 parts by weight of monomer units having a pendent, free-radically polymerizable functional group. Examples of such materials are available from Lucite International (Cordova, Tenn.) under the trade designations of ELVACITE 1010, ELVACITE 4026, and ELVACITE 4059.

The (meth)acrylated poly(meth)acrylate oligomer may comprise a blend of an acrylic or hydrocarbon polymer with multifunctional (meth)acrylate diluents. Suitable polymer/diluent blends include, for example, commercially available products such as EBECRYL 303, 745 and 1710 that are available from Allnex USA Inc., Alpharetta, Ga.

The curable polymeric binder may comprise a (meth)acrylated polybutadiene oligomer, which may be obtained from a carboxyl- or hydroxyl-functionalized polybutadiene. The carboxyl or hydroxy functionalized polybutadiene designates that the polybutadiene has free —OH or —COOH groups. Carboxyl functionalized polybutadienes are known and been described, for example, in U.S. Pat. No. 3,705,208 (Nakamuta et al.) and are commercially available under the trade name of NISSO PB C-1000 (Nisso America, New York, N.Y.). Carboxyl functionalized polybutadienes can also be obtained by the reaction of a hydroxyl functionalized polybutadiene (that is, a polybutadiene having free hydroxyl groups) with a cyclic anhydride such as has been described, for example, in U.S. Pat. No. 5,587,433 (Boeckeler), U.S. Pat. No. 4,857,434 (Klinger), and U.S. Pat. No. 5,462,835 (Mirle).

Carboxyl and hydroxyl functionalized polybutadienes suitable for use as curable polymeric binders contain units derived from the polymerization of butadiene in addition to the carboxyl (—COOH) and/or hydroxyl (—OH) groups. The polybutadiene (PDB) generally comprises 1-4 cis units/1-4 trans units/1-2 units in a ratio a/b/c where a, b and c range from 0 to 1 with a+b+c=1. The number average molecular weight (Mₙ) of the functionalized polybutadiene is preferably from 200 to 10,000 Da. The Mₙ is more preferably at least 1,000. The Mₙ more preferably does not exceed 5,000 Da. The carboxyl and/or hydroxyl functionality is generally from 1.5 to 9, preferably from 1.8 to 6.

Exemplary hydroxyl and carboxyl polybutadienes include without limitation POLY BD R-20LM (hydroxyl functionalized PDB, a=0.2, b=0.6, c=0.2, Mₙ 1230) and POLY BD R45-HT (hydroxyl functionalized PDB, a=0.2, b=0.6, c=0.2, Mₙ 2800) commercialized by Atofina, NISSO-PB G-1000 (hydroxyl functionalized PDB, a=0, b<0.15, c>0.85, Mₙ 1250-1650), NISSO-PB G-2000 (hydroxyl functionalized PDB, a=0, b<0.15, c>0.85, Mₙ 1800-2200), NISSO-PB G-3000 (hydroxyl functionalized PDB, a=0, b<0.10, c>0.90, Mₙ 2600-3200), and NISSO-PB C-1000 (carboxyl functionalized PDB, a=0, b<0.15, c>0.85, Mₙ 1200-1550) obtainable from Nisso America, New York, N.Y.

When carboxyl functionalized polybutadienes obtained from the reaction of a hydroxyl functionalized polybutadiene with a cyclic anhydride are used, this cyclic anhydride is often selected from phthalic anhydride, hexahydrophthalic anhydride, glutaric anhydride, succinic anhydride, dodecenylsuccinic anhydride, maleic anhydride, trimellitic anhydride, and pyromellitic anhydride. Mixtures of anhydrides can also be used. The amount of anhydride used for the preparation of a carboxyl functionalized polybutadiene from a hydroxyl functionalized polybutadiene is generally at least 0.8 molar, preferably at least 0.9 molar and more preferably at least 0.95 molar equivalent per molar equivalents of —OH groups present in the polybutadiene.

A (meth)acrylated polybutadiene oligomer, which is the reaction product of a carboxyl functionalized polybutadiene, may be prepared with a (meth)acrylated monoepoxide. (Meth)acrylated mono-epoxides are known. Examples of (meth)acrylated mono-epoxides that can be used are glycidyl (meth)acrylate esters, such as glycidylacrylate, glycidylmethacrylate, 4-hydroxybutylacrylate glycidylether, bisphenol-A diglycidylether monoacrylate. The (meth)acrylated mono-epoxides are preferably chosen from glycidylacrylate and glycidylmethacrylate. Alternatively, a (meth)acrylated polybutadiene oligomer which is the reaction product of a hydroxyl functionalized polybutadiene may be prepared with a (meth)acrylate ester, or halide.

Some (meth)acrylated polybutadienes that can be used, for example, include RICACRYL 3100 and RICACRYL 3500, manufactured by Sartomer Company, Exton, Pa., USA, and NISSO TE-2000 available from Nisso America, New York, N.Y. Alternatively, other methacrylated polybutadienes can be used. These include dimethacrylates of liquid polybutadiene resins composed of modified, esterified liquid polybutadiene diols. These are available under the tradename CN301, CN303, and CN307, manufactured by Sartomer Company, Exton, Pa., USA. Regardless which methacrylated polybutadiene is used, the methacrylated polybutadiene can include a number of methacrylate groups per chain from about 2 to about 20.

Alternatively, the acrylate functionalized oligomers can be polyester acrylate oligomers, acrylated acrylic oligomers, acrylated epoxy oligomers, polycarbonate acrylate oligomers, or polyether acrylate oligomers. Useful epoxy acrylate oligomers include CN2003B from Sartomer Co. (Exton, Pa.). Useful polyester acrylate oligomers include CN293, CN294, and CN2250, 2281, 2900 from Sartomer Co. (Exton, Pa.) and EBECRYL 80, 657, 830, and 1810 from UCB Chemicals (Smyrna, Ga.). Suitable polyether acrylate oligomers include CN501, 502, and 551 from Sartomer Co. (Exton, Pa.). Useful polycarbonate acrylate oligomers can be prepared according to U.S. Pat. No. 6,451,958 (Fan et al.).

In each embodiment comprising a (meth)acrylated oligomer, the curable binder composition optionally, yet preferably, comprises diluent monomer in an amount sufficient to reduce the viscosity of the curable composition such that it may be coated on a substrate. In some embodiments, the composition may comprise up to about 70 weight percent diluent monomers to reduce the viscosity of the oligomeric component to less than 10,000 centipoises and to improve the processability.

Useful monomers are desirably soluble or miscible in the (meth)acrylated oligomer and are highly polymerizable therewith. Useful diluents are mono- and poly-ethylenically unsaturated monomers such as (meth)acrylates or (meth)acrylamides. Suitable monomers typically have a number average molecular weight no greater than 450 g/mole. The diluent monomer desirably has minimal absorbance at the wavelength of the radiation used to cure the composition. Such diluent monomers may include, for example, n-butyl acrylate, isobutyl acrylate, hexyl acrylate, 2-ethyl-hexyl acrylate, isooctyl acrylate, caprolactone acrylate, isodecyl acrylate, tridecyl acrylate, lauryl methacrylate, methoxy-polyethylenglycol-mono methacrylate, lauryl acrylate, tetrahydrofurfuryl acrylate, ethoxy-ethoxyethyl acrylate, and ethoxylated-nonyl acrylate. In some embodiments, the monomers are 2-ethyl-hexylacrylate, ethoxy-ethoxyethyl acrylate, tridecylacrylate and ethoxylated nonylacrylate. High T_{g} monomers having one ethylenically unsaturated group and a glass transition temperature of the corresponding homopolymer of 50° C. or more which are suitable in the present invention, include, for example, N-vinylpyrrolidone, N-vinyl caprolactam, isobornyl acrylate, acryloylmorpholine, isobornyl (meth)acrylate, phenoxyethyl acrylate, phenoxyethyl methacrylate, methyl methacrylate, and acrylamide.

Furthermore, the diluent monomers may contain an average of two or more free-radically polymerizable groups. A diluent having three or more of such reactive groups can be present as well. Examples of such monomers include: C₂-C₁₈ alkylenediol di(meth)acrylates, C₃-C₁₈ alkylenetriol tri(meth)acrylates, the polyether analogues thereof, and the like, such as 1,6-hexanediol di(meth)acrylate, trimethylolpropane tri(meth)acrylate, triethyleneglycol di(meth)acrylate, pentaeritritol tri(meth)acrylate, and tripropyleneglycol di(meth)acrylate, and di-trimethylolpropane tetraacrylate.

Suitable preferred diluent monomers include, for example, benzyl (meth)acrylate, phenoxyethyl (meth)acrylate, phenoxy-2-methylethyl (meth)acrylate, phenoxyethoxyethyl (meth)acrylate, 1-naphthyloxy ethyl acrylate, 2-naphthyloxy ethyl acrylate, phenoxy 2-methylethyl acrylate, phenoxyethoxyethyl acrylate, 2-phenylphenoxy ethyl acrylate, 4-phenylphenoxy ethyl acrylate, and phenyl acrylate.

In some embodiments, the preferred diluent monomers include phenoxyethyl (meth)acrylate, benzyl (meth)acrylate, and tricyclodecane dimethanol diacrylate. Phenoxyethyl acrylate is commercially available from Sartomer under the trade designation SR339, from Eternal Chemical Co. Ltd. under the trade designation ETERMER 210, and from Toagosei Co. Ltd under the trade designation TO-1166. Benzyl acrylate is commercially available from Osaka Organic Chemical, Osaka City, Japan. Tricyclodecane dimethanol diacrylate is commercially available from Sartomer under the trade designation SR833S.

Such optional monomer(s) may be present in the polymerizable composition in amount of at least about 5 weight percent. The optional monomer(s) typically total no more than about 70 weight percent of the curable composition. In some embodiments the total amount of diluent monomer ranges from about 10 weight percent to about 50 weight percent.

When using a free-radically curable polymeric binder, the curable composition further comprises photoinitiators, in an amount in the range of about 0.1 weight percent to about 5 weight percent.

Useful photoinitiators include those known as useful for photocuring free-radically polyfunctional (meth)acrylates. Exemplary photoinitiators include benzoin and its derivatives such as alpha-methylbenzoin; alpha-phenylbenzoin; alpha-allylbenzoin; alpha30 benzylbenzoin; benzoin ethers such as benzil dimethyl ketal (e.g., “OMNIRAD 651” from IGM Resins USA Inc., St. Charles, Ill.), benzoin methyl ether, benzoin ethyl ether, benzoin n-butyl ether; acetophenone and its derivatives such as 2-hydroxy-2-methyl-1-phenyl-1-propanone (e.g., available under the trade designation OMNIRAD 1173 from IGM Resins USA Inc., St. Charles, Ill.) and 1-hydroxycyclohexyl phenyl ketone (e.g., available under the trade designation OMNIRAD 184 from IGM Resins USA Inc., St. Charles, Ill.); 2-methyl-1-[4-(methylthio)phenyl]-2-(4-morpholinyl)-1-propanone (e.g., available under the trade designation OMNIRAD 907 from IGM Resins USA Inc., St. Charles, Ill.); 2-benzyl-2-(dimethylamino)-1-[4-(4-morpholinyl)phenyl]-1-butanone (e.g., available under the trade designation OMNIRAD 369 from IGM Resins USA Inc., St. Charles, Ill.) and phosphine oxide derivatives such as ethyl-2,4,6-trimethylbenzoylphenyl phoshinate (e.g., available under the trade designation TPO-LG from IGM Resins USA Inc., St. Charles, Ill.), and bis-(2,4,6-trimethylbenzoyl)-phenylphosphineoxide (e.g., available under the trade designation OMNIRAD 819 from IGM Resins USA Inc., St. Charles, Ill.).

Other useful photoinitiators include, for example, pivaloin ethyl ether, anisoin ethyl ether, anthraquinones (e.g., anthraquinone, 2-ethylanthraquinone, 1-chloroanthraquinone, 1,4-dimethylanthraquinone, 1-methoxyanthraquinone, or benzanthraquinone), halomethyltriazines, benzophenone and its derivatives, iodonium salts and sulfonium salts, titanium complexes such as bis(eta5-2,4-cyclopentadien-1-yl)-bis[2,6-difluoro-3-(1H-pyrrol-1-yl) phenyl]titanium (e.g., available under the trade designation CGI 784DC from BASF, Florham Park, N.J.); halomethyl-nitrobenzenes (e.g., 4-bromomethylnitrobenzene), mono- and bis-acylphosphines (e.g., available under the trade designations IRGACURE 1700, IRGACURE 1800, and IRGACURE 1850 from BASF, Florham Park, N.J., and under the trade designation OMNIRAD 4265 from IGM Resins USA Inc., St. Charles, Ill.).

In some embodiments, the polymeric binder is an epoxy compound that can be cured or polymerized by the processes that are those known to undergo cationic polymerization and include 1,2-, 1,3-, and 1,4-cyclic ethers (also designated as 1,2-, 1,3-, and 1,4-epoxides). Suitable epoxy binders can include, for example, those epoxy binders described in U.S. Pat. No. 6,777,460 (Palazzotto et al.). In particular, cyclic ethers that are useful include the cycloaliphatic epoxies such as cyclohexene oxide, the cycloaliphatic epoxies under the trade designation CELLOXIDE from Daicel USA Inc., Fort Lee, N.J., and those under the trade designation SYNA from Synasia Inc. Metuchen, N.J., such as 4-vinyl-1-cyclohexene 1,2-epoxide, vinylcyclohexene dioxide, 3,4-epoxycyclohexylmethyl-3,4-epoxycyclohexane carboxylate, bis-(3,4-epoxycyclohexyl) adipate, 3,4-epoxycyclohexylmethyl-3′,4′-epoxycyclohexanecarboxylate modified epsilon-caprolactone, and 2-(3,4-epoxycylclohexyl-5, 5-spiro-3,4-epoxy) cyclohexene-meta-dioxane; also included are the glycidyl ether type epoxy binders such as propylene oxide, epichlorohydrin, styrene oxide, glycidol, the EPON, EPONEX, and HELOXY series type of epoxy binders available from Hexion Inc., Columbus, Ohio, including the diglycidyl either of bisphenol A and chain extended versions of this material such as EPON 828, EPON 1001, EPON 1004, EPON 1007, EPON 1009 and EPON 2002 or their equivalent from other manufacturers, EPONEX 1510, the hydrogenated diglycidyl either of bisphenol A, HELOXY 67, diglycidyl ether of 1,4-butanediol, HELOXY 107, diglycidyl ether of cyclohexane dimethanol, or their equivalent from other manufacturers, dicyclopentadiene dioxide, epoxidized vegetable oils such as epoxidized linseed and soybean oils available as VIKOLOX and VIKOFLEX binders from Arkema Inc., King of Prussia, Pa., epoxidized KRATON LIQUID POLYMERS, such as L-207 available from Kuraray Co. Ltd., Tokyo, Japan, epoxidized polybutadienes such as the POLY BD binders from Total Cray Valley, Exton, Pa., 1,4-butanediol diglycidyl ether, polyglycidyl ether of phenolformaldehyde, and for example DEN epoxidized phenolic novolac binders such as DEN 431 and DEN 438 available from Dow Chemical Co., Midland Mich., epoxidized cresol novolac binders such as ARALDITE ECN 1299 available from Huntsman Advanced Materials, The Woodlands, Tex., resorcinol diglycidyl ether, and epoxidized polystyrene/polybutadiene blends such as the EPOFRIEND binders such as EPOFRIEND A1010 available from Daicel USA Inc., Fort Lee, N.J., and resorcinol diglycidyl ether.

Higher molecular weight polyols include the polyethylene and polypropylene oxide polymers in the molecular weight (Mn) range of 200 to 20,000 such as the CARBOWAX polyethyleneoxide materials available from Dow Chemical Co., Midland, Mich., polycaprolactone polyols in the molecular weight range of 200 to 5,000 such as the CAPA polyol materials available from Perstorp Holding AB, Malmö, Sweden, polytetramethylene ether glycol in the molecular weight range of 200 to 4,000, such as the TERATHANE materials available from DuPont and POLYTHF 250 from BASF, polyethylene glycol, such as PEG 200 available from Dow, hydroxyl-terminated polybutadiene binders such as the POLY BD materials available from Arkema Inc., King of Prussia, Pa., phenoxy binders such as those commercially available from Gabriel Performance Products, Akron, Ohio, or equivalent materials supplied by other manufacturers.

It is also within the scope of this invention to include one or more epoxy binders that can be blended together. It is also within the scope of this invention to include one or more mono or poly-alcohols which can be blended together. The different kinds of polymeric binders and alcohols can be present in any proportion.

Further, vinyl ether monomers can be used as a cationically curable material. Vinyl ether-containing monomers can be ethyl vinyl ether, tert-butyl vinyl ether, isobutyl vinyl ether, cyclohexyl vinyl ether, 2-ethylhexyl vinyl ether, diethyleneglycol divinyl ether, triethyleneglycol divinyl ether, 1,4-butanediol divinyl ether, 1,4-cyclohexanedimethanol mono vinyl ether, and 1,4-cyclohexanedimethanol divinyl ether, (all available from BASF Corp., Florham Park, N.J.). Other vinyl ether monomers include methyl vinyl ether and trimethylolpropane trivinyl ether. It is within the scope of this invention to use a blend of more than one vinyl ether binder.

It is also within the scope of this invention to use one or more epoxy binders blended with one or more vinyl ether binders. The different kinds of binders can be present in any proportion.

In some embodiments, the preferred epoxy binders include the CELLOXIDE and SYNA type of binders especially 3,4-epoxycyclohexylmethyl 3,4-epoxycyclohexanecarboxylate, bis-(3,4-epoxycyclohexyl) adipate and 2-(3,4-epoxycylclohexyl-5,5-spiro-3,4-epoxy) cyclohexene-meta-dioxane and the bisphenol A EPON type binders including 2,2-bis-p-(2,3-epoxypropoxy) phenylpropane and chain extended versions of this material, and binders of the type EPONEX 1510, HELOXY 107, and HELOXY 68. Also useful in the present invention are purified versions of these epoxies as described in U.S. Patent Application Publication 2002/0022709 (Mader).

When preparing compositions containing epoxy monomers, hydroxy-functional materials can be added. The hydroxyl-functional component can be present as a mixture or a blend of materials and can contain mono- and polyhydroxyl containing materials. Preferably, the hydroxy-functional material is at least a diol. When used, the hydroxyl-functional material can aid in chain extension and in preventing excess crosslinking of the epoxy during curing, e. g., increasing the toughness of the cured composition.

When present, useful hydroxyl-functional materials include aliphatic, cycloaliphatic or alkanol-substituted arene mono- or poly-alcohols having from about 2 to about 18 carbon atoms and two to five, preferably two to four hydroxy groups, or combinations thereof. Useful mono-alcohols can include methanol, ethanol, 1-propanol, 2-propanol, 2-methyl-2-propanol, 1-butanol, 2-butanol, 1-pentanol, neopentyl alcohol, 3-pentanol, 1-hexanol, 1-heptanol, 1-octanol, 2-phenoxyethanol, cyclopentanol, cyclohexanol, cyclohexylmethanol, 3-cyclohexyl-1-propanol, 2-norbornanemethanol and tetrahydrofurfuryl alcohol.

Polyols useful in the present invention include aliphatic, cycloaliphatic, or alkanol-substituted arene polyols, or mixtures thereof having from about 2 to about 18 carbon atoms and two to five, preferably two to four hydroxyl groups. Examples of useful polyols include 1,2-ethanediol, 1,2-propanediol, 1,3-propanediol, 1,4-butanediol, 1,3-butanediol, 2-methyl-1,3-propanediol, 2, 2-dimethyl-1,3-propanediol, 2-ethyl-1,6-hexanediol, 1,5-pentanediol, 1,6-hexanediol, 1,8-octanediol, neopentyl glycol, glycerol, trimethylolpropane, 1,2, 6-hexanetriol, trimethylolethane, pentaerythritol, quinitol, mannitol, sorbitol, diethylene glycol, triethylene glycol, tetraethylene glycol, glycerine, 2-ethyl-2-(hydroxymethyl)-1,3-propanediol, 2-ethyl-1,3-pentanediol, 1,4-cyclohexanedimethanol, 1,4-benzene-dimethanol and polyalkoxylated bisphenol A derivatives. Other examples of useful polyols are disclosed in U.S. Pat. No. 4,503,211.

Bi-functional monomers having both cationically polymerizable and free-radically polymerizable moieties in the same monomer are useful in the curable compositions, such as, for example, glycidyl methacrylate, or 2-hydroxyethyl acrylate. Further, the addition of a free radically polymerizable monomer, such as an acrylate or methacrylate can broaden the scope of obtainable physical properties and processing options. When two or more polymerizable monomers are present, they can be present in any proportion.

Suitable cationic photoinitiators are selected from organic onium cations, for example those described in the book J. V. Crivello & K. Dietliker, Photoinitiators for Free Radical Cationic & Anionic Photopolymerization, 2nd Edition, John Wiley and Sons, 1998, pp. 275 to 298, and U.S. Pat. No. 4,250,311 (Crivello), U.S. Pat. No. 3,708,296 (Schlesinger et al.), U.S. Pat. No. 4,069,055 (Crivello), U.S. Pat. No. 4,216,288 (Crivello), U.S. Pat. No. 5,084,586 (Farooq), and U.S. Pat. No. 5,124,417 (Farooq). The cationic photoinitiators include aliphatic or aromatic Group IVA-VIIA (CAS version) centered onium salts, preferably I-, S-, P- and C-centered onium salts, such as those selected from sulfoxonium, diaryliodonium, triarylsulfonium, carbonium and phosphonium, and most preferably I-, and S-centered onium salts, such as those selected from sulfoxonium, diaryliodonium, and triarylsulfonium, wherein “aryl” in this context means an unsubstituted or substituted aromatic moiety having up to four independently selected substituents.

The quantum dot layer can have any useful amount of composite particles, and in some embodiments the quantum dot layer can include from 0.1 weight percent to 1 weight percent composite particles, based on the total weight of the quantum dot layer (e.g., composite particles, optional carrier fluid, and polymeric binder). In some embodiments, the composite particles are added to the carrier fluid in amounts such that the optical density of the dispersion is at least 10, optical density defined as the absorbance at 440 nm for a cell with a path length of 1 cm.

The dispersion composition can also contain a surfactant (i.e., leveling agent), a polymerization initiator, and other additives, as known in the art.

Generally, the composite particles, the optional surfactant, the polymeric binder and any carrier fluids (polymeric or non-polymeric) are combined and subject to high shear mixing to produce a dispersion. The polymeric binder is chosen such that there is limited compatibility and the carrier fluid form a separate, non-aggregating phase in the polymeric binder. The dispersion, comprising droplets of carrier fluid containing the composite particles dispersed in the polymeric binder, is then coated and cured either thermally, free-radically, or both to lock in the dispersed structure and exclude oxygen and water from the dispersed fluorescent semiconductor nanoparticles within the composite particles.

The curable composition comprising a free radically polymerizable polymeric binder may be irradiated with activating UV or visible radiation to polymerize the components preferably in the wavelengths of 250 to 500 nanometers. UV light sources can be of two types: 1) relatively low light intensity sources such as black lights that provide generally 10 mW/cm² or less (as measured in accordance with procedures approved by the United States National Institute of Standards and Technology as, for example, with a UVIMAP UM 365 L-S radiometer manufactured by Electronic Instrumentation & Technology, Inc., in Sterling, Va.) over a wavelength range of 280 to 400 nanometers and 2) relatively high light intensity sources such as medium- and high-pressure mercury arc lamps, electrodeless mercury lamps, light emitting diodes, mercury-xenon lamps, lasers and the like, which provide intensities generally between 10 and 5000 mW/cm² in the wavelength rages of 320-390 nm (as measured in accordance with procedures approved by the United States National Institute of Standards and Technology as, for example, with a POWER PUCK radiometer manufactured by Electronic Instrumentation & Technology, Inc., in Sterling, Va.).

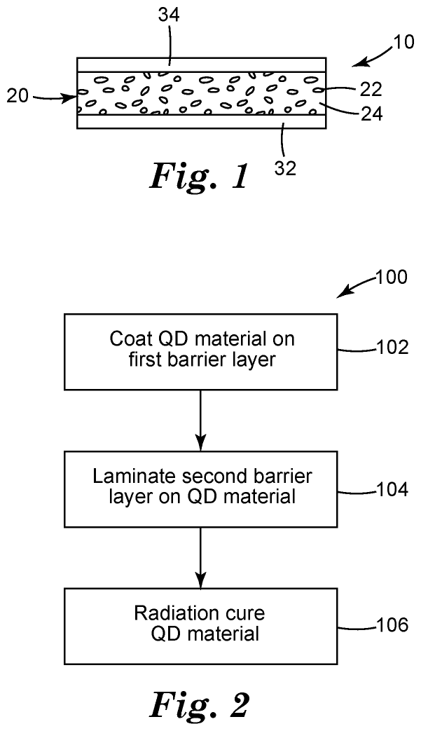

Referring to FIG. 1, quantum dot article 10 includes a first barrier layer 32, a second barrier layer 34, and a quantum dot layer 20 between the first barrier layer 32 and the second barrier layer 34. The quantum dot layer 20 includes a plurality of composite particles 22 dispersed in a polymeric binder 24, which may be cured or uncured.

The quantum dot layer can have any useful amount of composite particles. In some embodiments, the composite particles are added to the fluid carrier in amounts such that the optical density is at least 10, optical density defined as the absorbance at 440 nm for a cell with a path length of 1 cm.

The barrier layers 32, 34 can be formed of any useful material that can protect the fluorescent semiconductor material within the composite particles 22 from exposure to environmental contaminates such as, for example, oxygen, water, and water vapor. Suitable barrier layers 32, 34 include, but are not limited to, films of polymers, glass and dielectric materials. In some embodiments, suitable materials for the barrier layers 32, 34 include, for example, polymers such as polyethylene terephthalate (PET); oxides such as silicon oxide, titanium oxide, or aluminum oxide (e.g., SiO₂, Si₂O₃, TiO₂, or Al₂O₃); and suitable combinations thereof.

More particularly, barrier films can be selected from a variety of constructions. Barrier films are typically selected such that they have oxygen and water transmission rates at a specified level as required by the application. In some embodiments, the barrier film has a water vapor transmission rate (WVTR) less than about 0.005 g/m²/day at 38° C. and 100 percent relative humidity; in some embodiments, less than about 0.0005 g/m²/day at 38° C. and 100 percent relative humidity; and in some embodiments, less than about 0.00005 g/m²/day at 38° C. and 100 percent relative humidity. In some embodiments, the flexible barrier film has a WVTR of less than about 0.05, 0.005, 0.0005, or 0.00005 g/m²/day at 50° C. and 100 percent relative humidity or even less than about 0.005, 0.0005, 0.00005 g/m²/day at 85° C. and 100 percent relative humidity. In some embodiments, the barrier film has an oxygen transmission rate of less than about 0.005 g/m²/day at 23° C. and 90% relative humidity; in some embodiments, less than about 0.0005 g/m²/day at 23° C. and 90% relative humidity; and in some embodiments, less than about 0.00005 g/m²/day at 23° C. and 90% relative humidity.

Exemplary useful barrier films include inorganic films prepared by atomic layer deposition, thermal evaporation, sputtering, and chemical vapor deposition. Useful barrier films are typically flexible and transparent. In some embodiments, useful barrier films comprise inorganic/organic layers. Flexible ultra-barrier films comprising inorganic/organic multilayers are described, for example, in U.S. Pat. No. 7,018,713 (Padiyath et al.). Such flexible ultra-barrier films may have a first polymer layer disposed on polymeric film substrate that is overcoated with two or more inorganic barrier layers separated by at least one second polymer layer. In some embodiments, the barrier film comprises one inorganic barrier layer interposed between the first polymer layer disposed on the polymeric film substrate and a second polymer layer.

In some embodiments, each barrier layer 32, 34 of the quantum dot article 10 includes at least two sub-layers of different materials or compositions. In some embodiments, such a multi-layered barrier construction can more effectively reduce or eliminate pinhole defect alignment in the barrier layers 32, 34, providing a more effective shield against oxygen and moisture penetration into the cured polymeric binder 24. The quantum dot article 10 can include any suitable material or combination of barrier materials and any suitable number of barrier layers or sub-layers on either or both sides of the quantum dot layer 20. The materials, thickness, and number of barrier layers and sub-layers will depend on the particular application, and will suitably be chosen to maximize barrier protection and brightness of the composite particles 22 while minimizing the thickness of the quantum dot article 10. In some embodiments each barrier layer 32, 34 is itself a laminate film, such as a dual laminate film, where each barrier film layer is sufficiently thick to eliminate wrinkling in roll-to-roll or laminate manufacturing processes. In one illustrative embodiment, the barrier layers 32, 34 are polyester films (e.g., PET) having an oxide layer on an exposed surface thereof.

The quantum dot layer 20 can include one or more populations of composite particles 22. Exemplary composite particles 22 emit green light and red light upon down-conversion of blue primary light from a blue LED to secondary light emitted by the composite particles 22. The respective portions of red, green, and blue light can be controlled to achieve a desired white point for the white light emitted by a display device incorporating the quantum dot article 10. Exemplary composite particles 22 for use in the quantum dot articles 10 include, but are not limited to, InP with ZnS shells as the fluorescent semiconductor nanoparticles within the composite particles. Suitable fluorescent semiconductor nanoparticles for use in quantum dot articles described herein include, but are not limited to, core/shell fluorescent nanocrystals including CdSe/ZnS, InP/ZnS, PbSe/PbS, CdSe/CdS, CdTe/CdS or CdTe/ZnS.

In exemplary embodiments, the composite particles and carrier fluid are dispersed in a cured polymeric binder. Quantum dot and quantum dot materials 22 are commercially available from, for example, Nanosys Inc., Milpitas, Calif.

In one or more embodiments, the quantum dot layer 20 can optionally include scattering beads or particles. These scattering beads or particles have a refractive index that differs from the refractive index of the cured polymeric binder 24 by at least 0.05, or by at least 0.1. These scattering beads or particles can include, for example, polymers such as silicone, acrylic, nylon, and the like, or inorganic materials such as TiO₂, SiOₓ, AlOₓ, and the like, and combinations thereof. In some embodiments, including scattering particles in the quantum dot layer 20 can increase the optical path length through the quantum dot layer 20 and improve quantum dot absorption and efficiency. In many embodiments, the scattering beads or particles have an average particle size from 1 to 10 micrometers, or from 2 to 6 micrometers. In some embodiments, the quantum dot material 20 can optionally include fillers such fumed silica.

In some preferred embodiments, the scattering beads or particles are TOSPEARL 120A, 130A, 145A and 2000B spherical silicone resins available in 2.0, 3.0, 4.5 and 6.0 micron particle sizes respectively from Momentive Specialty Chemicals Inc., Columbus, Ohio.

The cured polymeric binder 24 of the quantum dot layer 20 can be formed from a polymeric binder or binder precursor that adheres to the materials forming the barrier layers 32, 34 to form a laminate construction, and also forms a protective matrix for the composite particles 22. In one embodiment, the cured polymeric binder 24 is formed by curing an epoxy amine polymer and an optional radiation-curable methacrylate compound.

Referring to FIG. 2, in another aspect, the present disclosure is directed to a method of forming a quantum dot film article 100 including coating a quantum dot material on the first barrier layer 102. The quantum dot material includes that composite particles and a polymeric binder or a precursor of the polymeric binder. The method further includes disposing a second barrier layer on the quantum dot material 104. That is the second barrier layer is laminated on the quantum dot material (laminated to the quantum dot layer). In some embodiments, the method 100 includes polymerizing (e.g., radiation curing) the radiation curable (meth)acrylate compound to form an at least partially cured quantum dot material.

In some embodiments, the binder composition can be cured or hardened by heating. In other embodiments, the binder composition may also be cured or hardened by applying radiation such as, for example, ultraviolet (UV) light. Curing or hardening steps may include UV curing, heating, or both. In some example embodiments that are not intended to be limiting, UV cure conditions can include applying about 10 mJ/cm² to about 4000 mJ/cm² of UVA, more preferably about 10 mJ/cm² to about 1000 mJ/cm² of UVA. Heating and UV light may also be applied alone or in combination to increase the viscosity of the binder composition, which can allow easier handling on coating and processing lines.

In some embodiments, the binder composition may be cured after lamination between the overlying barrier films 32, 34. Thus, the increase in viscosity of the binder composition locks in the coating quality right after lamination. By curing right after coating or laminating, in some embodiments the cured binder increases in viscosity to a point that the binder composition acts as a pressure sensitive adhesive (PSA) to hold the laminate together during the cure and greatly reduces defects during the cure. In some embodiments, the radiation cure of the polymeric binder provides greater control over coating, curing and web handling as compared to traditional thermal curing.

Once at least partially cured, the binder composition forms polymer network that provides a protective supporting cured polymeric binder 24 for the composite particles 22.

Ingress, including edge ingress, is defined by a loss in quantum dot performance due to ingress of moisture and/or oxygen into the cured polymeric binder 24. In various embodiments, the edge ingress of moisture and oxygen into the cured binder 24 is less than about 1.25 mm after 1 week at 85° C., or about less than 0.75 mm after 1 week at 85° C., or less than about 0.5 mm after 1 week at 85° C. In various embodiments, oxygen permeation into the cured polymeric binder is less than about 80 (cc.mil)/(m² day), or less than about 50 (cc.mil)/(m² day). In various embodiments, the water vapor transmission rate of the cured polymeric binder should be less than about 15 (20 g/m².mil.day), or less than about 10 (20 g/m².mil.day).

In various embodiments, the thickness of the quantum dot layer 20 is about 80 microns to about 250 microns.

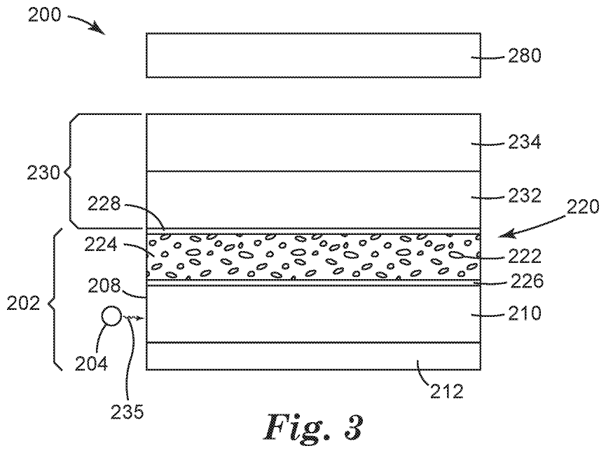

FIG. 3 is a schematic illustration of an embodiment of a display device 200 including the quantum dot articles described herein. This illustration is merely provided as an example and is not intended to be limiting. The display device 200 includes a backlight 202 with a light source 204 such as, for example, a light emitting diode (LED). The light source 204 emits light along an emission axis 235. The light source 204 (for example, a LED light source) emits light through an input edge 208 into a hollow light recycling cavity 210 having a back reflector 212 thereon. The back reflector 212 can be predominately specular, diffuse or a combination thereof, and is preferably highly reflective. The backlight 202 further includes a quantum dot article 220, which includes a protective binder 224 having dispersed therein composite particles 222. The protective cured polymeric binder 224 is bounded on both surfaces by polymeric barrier films 226, 228, which may include a single layer or multiple layers. The display device 200 further includes a front reflector 230 that includes multiple directional recycling films or layers, which are optical films with a surface structure that redirects off-axis light in a direction closer to the axis of the display, which can increase the amount of light propagating on-axis through the display device, this increasing the brightness and contrast of the image seen by a viewer. The front reflector 230 can also include other types of optical films such as polarizers. In one non-limiting example, the front reflector 230 can include one or more prismatic films 232 and/or gain diffusers. The prismatic films 232 may have prisms elongated along an axis, which may be oriented parallel or perpendicular to an emission axis 235 of the light source 204. In some embodiments, the prism axes of the prismatic films may be crossed. The front reflector 230 may further include one or more polarizing films 234, which may include multilayer optical polarizing films, diffusely reflecting polarizing films, and the like. The light emitted by the front reflector 230 enters a liquid crystal (LC) panel 280. Numerous examples of backlighting structures and films may be found in, for example, U.S. 2011/0051047 (O'Neill et al.).

Various embodiments are provided that include composite particles, compositions containing the composite particles, and articles containing the composite particles.

Embodiment 1A is a composite particle that comprises a fluorescent core/shell nanoparticle and a stabilizing additive comprising a phosphine compound having at least three phosphorous-containing electron donor groups.

Embodiment 2A is the composite particle of embodiment 1A, wherein each phosphorous-containing electron donor group has at least one aryl, aralkyl, or alkaryl group attached to a phosphorous atom.

Embodiment 3A is the composite particle of embodiment 1A or 2A, wherein the stabilizing additive is of Formula (I).

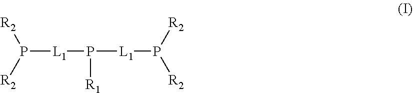

In Formula (I), each L₁ is independently an alkylene, arylene, or combination thereof; R₁ is an alkyl, aryl, alkaryl, aralkyl, or group of formula -L₂-P(R₂)₂; each R₂ is independently an alkyl, aryl, alkaryl, aralkyl, or two R₂ groups combined with the phosphorous atom to which they are both attached form a ring structure; and L₂ is an alkylene.

Embodiment 4A is the composite particle of embodiment 3A, wherein each R₂ is an aryl, alkaryl, or aralkyl.

Embodiment 5A is the composite particle of embodiment 3A or 4A, wherein each R₂ is an aryl, alkaryl, or aralkyl and R₁ is an aryl, alkaryl, or aralkyl. In some particular embodiments, each R₂ and R₁ is an aryl such as phenyl.

Embodiment 6A is the composite particle of any one of embodiments 3A to 5A, wherein each R₂ is an aryl, alkaryl, or aralkyl, group R₁ is an aryl, alkaryl, or aralkyl, and group L₁ is an alkylene.

Embodiment 7A is the composite particle of any one of embodiments 3A to 6A, wherein the stabilizing additive is

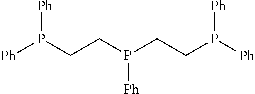

where Ph is phenyl.

Embodiment 8A is the composite particle of any one of embodiment 3A to 5A, wherein each R₂ is an aryl, alkaryl, or aralkyl, group R₁ is an aryl, alkaryl, or aralkyl, and group L₁ is an arylene.

Embodiment 9A is the composite particle of embodiment 8A, wherein the stabilizing additive is

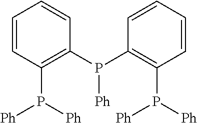

where Ph is phenyl.

Embodiment 10A is the composite particle of embodiment 3A or 4A, wherein each R₂ is an aryl, alkaryl, or aralkyl, group R₁ is of formula -L₂-P(R₂)₂, and groups L₁ and L₂ are each an alkylene.

Embodiment 11A is the composite particle of embodiment 10A, wherein the stabilizing additive is

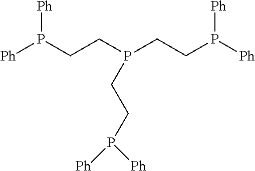

where Ph is phenyl.

Embodiment 12A is the composite particle of embodiment 1A or 2A, wherein the stabilizing additive is of Formula (II).

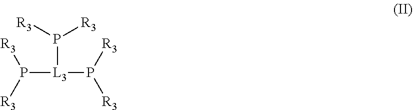

In Formula (II), each R₃ is independently an alkyl, aryl, alkaryl, aralkyl, or two R₃ groups combined with the phosphorous atom to which they are both attached form a ring structure; and L₃ is an alkane-triyl or a trivalent group of formula N(L₄)₃ where each L₄ is an alkylene.

Embodiment 13A is the composite particle of embodiment 12A, wherein each R₃ is an aryl, aralkyl, or alkaryl and L₃ is an alkane-triyl.

Embodiment 14A is the composite particle of embodiment 12A or 13A, wherein the stabilizing additive is

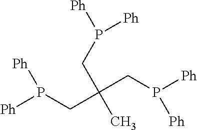

where each Ph is phenyl.

Embodiment 15A is the composite particle of embodiment 12A or 13A, wherein the stabilizing additive is

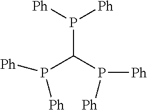

where each Ph is phenyl.

Embodiment 16A is the composite particle of embodiment 12A, wherein a first R₃ group attached to each phosphorous atom is an aryl, aralkyl, or alkaryl, a second R₃ group attached to each phosphorous atom is an alkyl, and L₃ is an alkane-triyl.

Embodiment 17A is the composite particle of embodiment 16A, wherein the stabilizing additive is

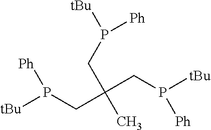

where Ph is phenyl and tBu is tert-butyl.

Embodiment 18A is the composite particle of embodiment 12A, wherein two R₃ groups combined with the phosphorous atom to which they are both attach to form a ring structure and group L₃ is an alkane-triyl.

Embodiment 19A is the composite particle of embodiment 18A, wherein the stabilizing additive is

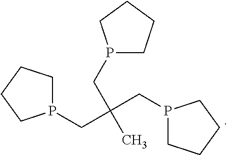 [SMILES: CC(CP1CCCC1)(CP1CCCC1)CP1CCCC1]

Embodiment 20A is the composite particle of embodiment 12A, wherein each R₃ is an aryl, aralkyl, or alkaryl and L₃ is trivalent group of formula N(L₄)₃ with each L₄ is an alkylene.

Embodiment 21A is the composite particle of embodiment 20A, wherein the stabilizing additive is

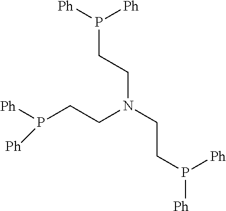

where each Ph is phenyl.

Embodiment 22A is the composite particle of any one of embodiments 1A to 21A, wherein the fluorescent core/shell nanoparticle is surface modified with a surface modifying ligand compound having a ligand group selected from surface modifying ligand compound has at least one ligand group selected from —CO₂H, —SO₃H, —P(O)(OH)₂, —OP(O)(OH), —OH, —SH, and —NH₂.

Embodiment 23A is the composite particle of embodiment 22A, wherein the surface modifying ligand compound is of Formula (III).

R₁₁—(X)ₙ (III)

In Formula (III), group R₁₁ is a (hetero)hydrocarbyl group having 2 to 30 carbon atoms. The variable n is an integer equal to at least one (such as, for example, 1 to 5, 1 to 4, or 1 to 3), and X is a ligand group selected from —COOH, —SO₃H, —P(O)(OH)₂, —OP(O)(OH), —OH, —SH, and —NH₂.

Embodiment 24A is the composite particle of embodiment 23A, wherein the surface modifying ligand compound is selected from C₂₋₁₈ alkylcarboxylic acids, C₂₋₁₈ alkenylcarboxylic acids, C₂₋₁₈ alkylsulfonic acids, C₂₋₁₈ alkenylsulfonic acids, C₂₋₁₈ phosphonic acids, C₂₋₁₈ alkylamines, and C₂₋₁₈ alkenylamines.

Embodiment 25A is the composite particle of embodiment 24A, wherein the surface modifying ligand compound has multiple carboxylic acid groups.

Embodiment 26A is the composite particle of embodiment 23A, wherein the surface modifying ligand compound is an alkylsuccinic acid, oleic acid, stearic acid, palmitic acid, lauric acid, dodecylsuccinic acid, hexylphosphonic acid, n-octylphosphonic acid, tetradecylphosphonic acid, octadecylphosphonic acid, n-octyl amine, or hexadecyl amine.

Embodiment 27A is the composite particle of embodiment 23A, wherein the surface modifying ligand compound is a malonic acid derivative such as tridecylmalonic acid, bis(4,6,6-trimethylhexyl)malonic acid, or 2-(3,5,5-trimethylhexylidine)propanedioic acid.

Embodiment 28A is the composite particle of any one of embodiments 1A to 27A, wherein the fluorescent semiconductor nanoparticle includes elements or complexes of Group 2-Group 16, Group 12-Group 16, Groups 13-Group 15, Group 14-Group 16, or Group 14 of the Periodic Table (using the modern group numbering system 1-18).

Embodiment 29A is the composite particle of any one of embodiments 1A to 28A, wherein the fluorescent core/shell nanoparticle has a core comprising InP, CdSe, or CdS.

Embodiment 30A is the composite particle of any one of embodiments 1A to 29A, further comprising a second stabilizing additive of Formula (IV).

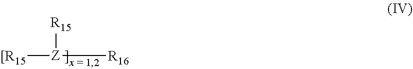

In Formula (IV), group R₁₅ is a tri(alkyl)silyl group or a hydrocarbyl group such as an alkyl, alkenyl, aryl, alkaryl, or aralkyl. The hydrocarbyl R₁₅ group optionally can be substituted with a halo or alkoxy. When the variable x is equal to 1, group R₁₆ is equal to R₁₅. That is, R₁₆ is an alkyl, alkenyl, aryl, alkaryl, aralkyl, or tri(alkyl)silyl wherein any of these groups optionally can be substituted with a halo or alkoxy. When the variable x is equal to 2, R₁₆ is a divalent alkylene. Group Z is P, As or Sb.

Embodiment 1B is a composition comprising a) a composite particle of embodiment 1A and b) a carrier fluid, a polymeric binder, a precursor of the polymeric binder, or a mixture thereof.

Embodiment 2B is the composition of embodiment 1B, wherein the composite particle is any one of embodiments 2A to 30A.

Embodiment 3B is the composition of embodiment 1B or 2B, wherein the composite particle is dispersed in the carrier fluid, dispersed in the polymeric binder, dispersed in the precursor of the polymeric binder, or a combination thereof.

Embodiment 4B is the composition of any one of embodiments 1B to 3B, wherein the composite particle is dispersed in the carrier fluid.

Embodiment 5B is the composition of any one of embodiments 1B to 4B, wherein the composite particle is dispersed in the carrier fluid as a first dispersion and the first dispersion is dispersed in the precursor of the polymeric binder as a second dispersion.

Embodiment 6B is the composition of embodiment 5B, wherein the precursor of the polymeric binder has free-radically polymerizable groups.

Embodiment 7B is the composition of any one of embodiments 1B to 4B, wherein the composite particle is dispersed in the carrier fluid as a first dispersion and the first dispersion is dispersed in the polymeric binder.

Embodiment 8B is the composition of any one of embodiments 1B to 3B, wherein the composite particle is dispersed in the polymeric binder.

Embodiment 9B is the composition of embodiment 8B, wherein the polymeric binder is cured (i.e., crosslinked).

Embodiment 10B is the composition of embodiment 1B to 3B, wherein the precursor of the polymeric binder has free-radically polymerizable groups.

Embodiment 1C is an article that comprises a quantum dot layer comprising composite particles dispersed in a polymeric binder, wherein the composite particles are of embodiment 1A.

Embodiment 2C is the article of embodiment 1C, wherein the composite particles are of any of embodiment 2A to 30A.

Embodiment 3C is the article of embodiment 1C or 2C, wherein the quantum dot layer further comprises a carrier fluid and wherein the composite particles are dispersed in the carrier fluid as a first dispersion and the first dispersion is dispersed in the polymeric binder as a second dispersion.

Embodiment 4C is the article of any one of embodiments 1C to 3C, further comprising two barrier films, wherein the quantum dot layer is positioned between the two barrier films.

Embodiment 5C is the article of any one of embodiments 1C to 4C, wherein the quantum dot layer comprises one or more different populations of composite particles.

Embodiment 6C is the article of embodiment 5C, wherein the different populations of composite particles emit green light, blue light, and red light.

Embodiment 7C is the article of any one of embodiments 1C to 6C, wherein the fluorescent semiconductor nanoparticles are selected from CdSe/ZnS, InP/ZnS, PbSe/PbS, CeSe/CdS, CdTe/CdS, and CdTe/ZnS.

Embodiment 8C is the article of any one of embodiments 1C to 7C, wherein the article is a quantum dot enhancement film.

Embodiment 9C is the article of any one of embodiments 1C to 8C, wherein the article is a component of an optical display.

Embodiment 10C is the article of any one of embodiments 1C to 9C, wherein the article is a component of a liquid crystal display.

### EXAMPLES

All materials were obtained from commercial sources and used as received.

TABLE 1
Materials

| Designation | Description | Source |
|---|---|---|
| Triphos | Bis(2-phenylphosphinoethyl) | Strem Chemical |
| | phenylphosphine | (Newburyport, MA) |
| InP/Green/ | Green fluorescing InP quantum dots | Nanosys |
| heptane | in heptane, used as received, | (Milpitas, CA) |
| | Lot# ISWG110215-21B | |
| InP/Red/ | Red fluorescing InP quantum dots | Nanosys |
| heptane | in heptane, used as received, | (Milpitas, CA) |
| | Lot # 378-183 | |
| Toluene | Anhydrous, air free toluene in | Sigma Aldrich |
| | 1 liter (L) bottles | (St. Louis, MO) |

### Test Methods

### Quantum Yield Measurements

Four-sided quartz fluorescence cells (NSG Precision Cells, Farmingdale, N.Y.) were used to hold approximately 4.0 milliliters (mL) of test samples when collecting quantum yield measurements. The cells were cleaned as follows: three rinses each of toluene, absolute ethanol, and DI water, followed by a 15 minute soak with dilute HNO₃, then three rinses with DI water followed by a 10-15 minute soak with saturated NaCO₃ solution, and three rinses each of DI water, followed by absolute ethanol, and finally toluene. Cells were allowed to dry at room temperature for at least 24 hours before using for solution quantum yield measurements.

Quantum yield measurements were made on a HAMAMATSU ABSOLUTE PL QUANTUM YIELD SPECTROMETER C11347, available from Hamamatsu Photonics, Hamamatsu, Japan. An excitation wavelength of 440 nm was used for all measurements. Fluorescence spectra were analyzed using the PLQY Measurement Software U6039-05 supplied with the instrument. A built-in correction program, supplied by the manufacturer, was used to correct the emission spectra for self-absorption to give corrected quantum yields. All measurements reported in the tables are corrected quantum yield measurements. The peak position was determined for the peak maximum in the corrected spectra curves, and the full width at half maximum value (FWHM) was calculated from the emission peak in the corrected spectra curves. Three separate measurements were made on each quantum dot solution in a random order. A fluorescence cell filled with toluene was used as a blank.

### Examples 1A and 2A (EX-1A and EX-2A): Stabilizing Additive Performance

Quantum dot solutions were prepared in a MBRAUN LABMASTER SP (Stratham, N.H.) glove box workstation under an argon atmosphere.

For sample preparation, 23 mL glass vials with Teflon lids were used. The vials were kept in a drying oven at 60° C. prior to use to minimize any surface water. Since the stabilizing additives themselves are air stable, specified amounts of the additive were weighed out into the vials in the lab atmosphere before entering the glove box workstation. All containers and equipment to be used in a test were placed in the antechamber of the glove box and pumped on for at least 20 minutes before starting an automatic pump/refill cycle used to bring items into the glove box.

Once in the glove box, 10 mL of toluene was pipetted into each vial using a 5 mL EPPENDORF pipette (Eppendorf North America, Hauppauge, N.Y.). The samples were stirred manually to ensure that all of the additive had dissolved before adding 50 microliters (μL) (using a 100 μL EPPENDORF pipette, Eppendorf North America, Hauppauge, N.Y.) of the appropriate quantum dot solution (InP/Green/heptane quantum dots or InP/Red/heptane quantum dots) to each vial, followed by hand stirring. A vial that contained no additional stabilizing additive was also prepared as a control example for each quantum dot solution (CE-1A for InP/Green/heptane quantum dots and CE-2A for InP/Red/heptane quantum dots). A toluene blank was prepared that contained no added quantum dot materials or stabilizing additive.

Four (4) mL of each test solution was then pipetted into a separate fluorescence cell. Each fluorescence cell was sealed with a rubber septum, and the sealed cells were removed from the glove box to make quantum yield measurements. The PLQY Measurement Software U6039-05 supplied with the instrument was used to analyze the emission spectra to calculate the desired spectral quantities. A built-in correction program was used to correct the emission spectra for self-absorption to give corrected quantum yields. The peak position was determined for the peak maximum in the corrected spectra curve. Results of the quantum yield measurements were as summarized in Table 2. FWHM refers to the full width at half maximum of the peak.

TABLE 2
Summary of quantum yield measurements

| | | | | Peak | |
|---|---|---|---|---|---|
| | | Amount of | Quantum | Wave- | Peak |
| | | Additive | Yield | length | FWHM |
| Example | Additive | (mg) | (Corrected) | (nm) | (nm) |
| CE-1A | No additive | N/A | 0.575 | 524 | 40.9 |
| EX-1A | Triphos | 100.0 | 0.724 | 524 | 40.6 |
| CE-2A | No additive | N/A | 0.538 | 620 | 53.4 |
| EX-2A | Triphos | 98.0 | 0.743 | 618 | 52.5 |

### Examples 1B and 2B (EX-1B and EX-2B): Stability to Light Exposure of InP Quantum Dots

After the initial quantum dot solution measurements were taken in Examples EX-1A and EX-2A as well as Comparative Examples CE-1A and CE-2A, the samples were kept in the fluorescence cells and tested for light stability. The solutions, including the toluene blank, were irradiated for two hours using two 15 Watt Philips TLD bulbs having a spectral output centered at 420 nm (EX-1B for InP/Green/heptane quantum dots with triphos additive, EX-2B for InP/Red/heptane quantum dots with triphos additive, CE-1B for InP/Green/heptane quantum dots, and CE-2B for InP/Red/heptane quantum dots). After irradiation, the quantum yield of the irradiated solutions was measured once. Tables 3 and 4 compare the change in quantum yield and the change in full width half-maximum of the InP solutions upon irradiation. FWHM refers to the full width at half maximum of the peak.

TABLE 3
InP/Green/heptane light stability measurements made in toluene

| | | | Quantum yield | | Change in | Peak FWHM (nm) | |
|---|---|---|---|---|---|---|---|
| | | Amount | Before | After | quantum | Before | After |
| Example | Additive | (mg) | irradiation | irradiation | yield | irradiation | irradiation |
| CE-1B | No additive | N/A | 0.575 | 0.358 | −38% | 40.9 | 43.4 |
| EX-1B | Triphos | 100.0 | 0.724 | 0.618 | −15% | 40.6 | 40.5 |

TABLE 4
InP/Red/heptane light stability measurements made in toluene

| | | | Quantum yield | | Change in | Peak FWHM (nm) | |
|---|---|---|---|---|---|---|---|
| | | Amount | Before | After | quantum | Before | After |
| Example | Additive | (mg) | irradiation | irradiation | yield | irradiation | irradiation |
| CE-2B | No additive | N/A | 0.538 | 0.379 | −30% | 53.4 | 59.5 |
| EX-2B | Triphos | 98.0 | 0.743 | 0.713 | −4% | 52.5 | 52.1 |

1. A composite particle comprising:
a fluorescent core/shell nanoparticle; and
a stabilizing additive comprising a phosphine compound having at least three phosphorous-containing electron donor groups.

2. The composite particle of claim 1, wherein the fluorescent core/shell nanoparticle is surface modified with a surface modifying ligand compound having a ligand group selected from surface modifying ligand compound having at least one ligand group selected from —CO₂H, —SO₃H, —P(O)(OH)₂, —OP(O)(OH), —OH, —SH, and —NH₂.

3. The composite particle of claim 1, wherein the fluorescent core/shell nanoparticle has a core comprising InP, CdSe, or CdS.

4. The composite particle of claim 1, wherein the stabilizing additive is of Formula (I) 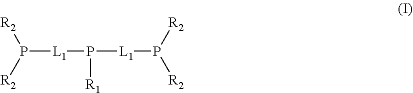
wherein
each L₁ is independently an alkylene, arylene, or combination thereof;
R₁ is an alkyl, aryl, alkaryl, aralkyl, or group of formula -L₂-P(R₂)₂;
each R₂ is independently an alkyl, aryl, alkaryl, aralkyl, or two R₂ groups combined with the phosphorous atom to which they are both attached form a ring structure; and
L₂ is an alkylene.

5. The composite particle of claim 4, wherein each R₂ is an aryl, aralkyl, or aralkyl.

6. The composite particle of claim 4, wherein R₁ and each R₂ are phenyl.

7. The composite particle of claim 1, wherein the stabilizing additive is of Formula (II) 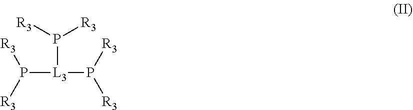
wherein
each R₃ is independently an alkyl, aryl, alkaryl, aralkyl, or two R₃ groups combined with the phosphorous atom to which they are both attached form a ring structure; and
L₃ is an alkane-triyl or a trivalent group of formula N(L₄)₃ where each L₄ is an alkylene.

8. A composition comprising:
a composite particle of claim 1; and
a carrier fluid, a polymeric binder, a precursor of the polymeric binder, or a mixture thereof.

9. The composition of claim 8, wherein the composite particle is dispersed in the carrier fluid, dispersed in the polymeric binder, dispersed in the precursor of the polymeric binder, or a combination thereof.

10. The composition of claim 9, wherein the composite particle is dispersed in the carrier fluid as a first dispersion and the first dispersion is dispersed in the polymeric binder as a second dispersion.

11. The composition of claim 8, wherein the composite particle is surface modified with a surface modifying ligand compound having a ligand group selected from surface modifying ligand compound having at least one ligand group selected from —CO₂H, —SO₃H, —P(O)(OH)₂, —OP(O)(OH), —OH, —SH, and —NH₂.

12. An article comprising a quantum dot layer comprising composite particles dispersed in a polymeric binder, wherein the composite particles are of claim 1.

13. The article of claim 12, wherein the quantum dot layer further comprises a carrier fluid and wherein the composite particles are dispersed in the carrier fluid as a first dispersion and the first dispersion is dispersed in the polymeric binder as a second dispersion.

14. The article of claim 12, further comprising two barrier films, wherein the quantum dot layer is positioned between the two barrier films.

15. The article of claim 12, wherein the composite particles comprise fluorescent core/shell nanoparticles surface modified with a surface modifying ligand compound having a ligand group selected from surface modifying ligand compound having at least one ligand group selected from —CO₂H, —SO₃H, —P(O)(OH)₂, —OP(O)(OH), —OH, —SH, and —NH₂.
